(19) United States
(12) Patent Application Publication
(10) Pub. No.: US 2026/0138156 A1
(43) Pub. Date: May 21, 2026

(54) SHAKER

(71) Applicant: PSS BELGIUM NV, Dendermonde (BE)

(72) Inventor: Giuseppe DI CARLANTONIO, Dendermonde (BE)

(21) Appl. No.: 19/121,476

(22) PCT Filed: Dec. 7, 2023
(86) PCT No.: PCT/EP2023/084674

§ 371 Date: Apr. 16, 2025

(30) Foreign Application Priority Data
Dec. 14, 2022 (GB) 2218833.8

(51) Int. Cl. B06B 1/04

(52) U.S. Cl. CPC B06B 1/045

(57) ABSTRACT

A shaker for transmitting vibrations has: a frame, including an application attachment surface; a magnet unit to provide a magnetic field in an air gap; a coil assembly including a voice coil mounted to a voice coil former that is attached to the frame at a voice coil former attachment surface. The voice coil former positions the voice coil in the air gap, when the magnet unit is in a rest position. The magnet unit moves along a movement axis when the shaker is activated. The magnet unit is suspended by a suspension arrangement that includes proximal and distal suspensions, wherein the proximal suspension is closer to the voice coil former attachment surface than the distal suspension when the shaker is at rest. One suspension includes an elastomeric material which resiliently stretches such that the stiffness increases as the magnet unit moves from the rest position.

This application claims priority to GB2218833.8, filed 14 Dec. 2022.

### FIELD OF THE INVENTION

The present invention relates to a shaker for transmitting vibrations to an application.

### BACKGROUND

Shakers, for transmitting vibrations to an application, are known. Such devices are sometimes known as electrodynamical shakers or electromechanical shakers.

A shaker, if attached to a car seat (e.g. via a frame of the car seat, via foam of the car seat, or via other coupling features of the car seat), can be used for transmitting vibrations to a person sat in the car seat. Such vibrations can be used to provide a tactile warning to a person sat in the seat, to provide a massage to a person sat in the seat, and/or to enhance a listening experience to a person sat in the seat (e.g. by helping them “feel” bass sounds more strongly).

Shakers which use two suspensions for providing stability against rocking motion are known, see e.g. U.S. Pat. No. 4,354,067 (Yamada), U.S. Pat. No. 4,675,907 (Itagaki).

Shakers which use just one (metal) suspension are also known, see e.g. U.S. Pat. No. 6,377,145B1 (Kumagai) and U.S. Pat. No. 7,372,968B2 (Buos). In Buos, it is proposed to configure the single suspension to act in a plane generally passing through the centre of mass of a magnet unit, to reduce rocking motion.

However, as discussed below in more detail, the present inventors have found that existing shaker designs which have two suspensions can be difficult and expensive to manufacture. Although these issues become less of a problem if only one metal suspension is used in a shaker, the present inventors have found shakers which include only one metal suspension are vulnerable to rocking motion, even if the single suspension is mounted as described in Buos.

GB2108925.5, extracts from which are enclosed herein as an Annex, discloses a shaker for transmitting vibrations to an application, the shaker having:
a frame, including an application attachment surface for attaching the shaker to the application;
a magnet unit configured to provide a magnetic field in an air gap;
a coil assembly including a voice coil mounted to a voice coil former, wherein the voice coil former is attached to the frame at a voice coil former attachment surface on the frame, wherein the voice coil former is configured to position the voice coil in the air gap, when the shaker is at rest;
wherein the magnet unit is configured to move relative to the voice coil along a movement axis of the shaker when the shaker is activated by supplying electrical current to the voice coil;
wherein the magnet unit is suspended from the frame by a suspension arrangement that includes a proximal suspension which interconnects the frame and the magnet unit and a distal suspension which interconnects the frame and the magnet unit, wherein the proximal suspension is closer to the voice coil former attachment surface on the frame than the distal suspension when the shaker is at rest;
wherein one of the proximal and distal suspensions has a stiffness K₁, and the other of the proximal and distal suspensions has a stiffness K₂, wherein K₂>K₁, and the ratio K₁/K₂ is 0.4 or less.

The inventor of GB2108925.5 found that the use of two suspensions, at different locations along the movement axis, helps reduce rocking motion compared with the use of a single suspension. As there are two suspensions, there is no need to mount a suspension to act in a plane generally passing through the centre of mass of a magnet unit to reduce rocking motion (unlike Buos, described above).

However, the present inventor has found that shakers according to the teaching of GB2108925.5 can degrade over time because the suspensions can fatigue and become less effective. In addition, the present inventors have observed that the suspension having the stiffness K₁ may be prone to tearing when the magnet unit reaches its maximum extent or when the shaker is being used with high excitation forces.

US2013/0076162 A1 proposes a single, perforated suspension element made of silicon rubber to connect a moving mass and a frame. However, US2013/0076162 A1 is directed to microspeakers which have much smaller moving masses than shakers and the present inventor has found that using a single suspension element made of rubber, as described in US2013/0076162 A1, can result in undesirable instability and rocking in shakers. In addition, the use of silicon rubber is not preferred because it can be difficult to glue which introduces added complexity and cost during manufacture.

The present invention has been devised in light of the above considerations.

### SUMMARY OF THE INVENTION

In a first aspect, the present invention may provide: A shaker for transmitting vibrations to an application, the shaker having:
a frame, including an application attachment surface for attaching the shaker to the application;
a magnet unit configured to provide a magnetic field in an air gap;
a coil assembly including a voice coil mounted to a voice coil former, wherein the voice coil former is attached to the frame at a voice coil former attachment surface on the frame, wherein the voice coil former is configured to position the voice coil in the air gap, when the magnet unit is in a rest position and the shaker is at rest;
wherein the magnet unit is configured to move relative to the voice coil along a movement axis of the shaker when the shaker is activated by supplying electrical current to the voice coil;
wherein the magnet unit is suspended from the frame by a suspension arrangement that includes a proximal suspension which interconnects the frame and the magnet unit and a distal suspension which interconnects the frame and the magnet unit, wherein the proximal suspension is closer to the voice coil former attachment surface on the frame than the distal suspension when the shaker is at rest;
wherein one of the proximal and distal suspensions includes an elastomeric material which is configured to resiliently stretch such that the stiffness of the suspension that includes the elastomeric material increases as the magnet unit moves along the movement axis away from the rest position.

The present inventors have found that including an elastomeric material in one of the proximal and distal suspensions results in an increased amount of mechanical damping being applied to the magnet unit by the suspension that includes the elastomeric material as the magnet unit moves away from the rest position. In this way, the suspension that includes the elastomeric material may provide additional protection for the other suspension by alleviating the stresses on that other suspension when the magnet unit moves close to its furthest extent, compared with if a non-elastomeric material were used (e.g. a textile suspension, as in GB2108925.5). Accordingly, the progressivity in mechanical damping introduced by the suspension that includes the elastomeric material may reduce fatigue on the suspension that includes the elastomeric material, help the suspension that includes the elastomeric material be less prone to tearing, and thus increase the durability of the shaker.

In addition, the progressively increasing stiffness and the increased mechanical damping provided by suspension that includes the elastomeric material can reduce the quality factor of the shaker and therefore lower the maximum displacement of the magnet unit at the resonant frequency. This can reduce instances of the shaker bottoming out, wherein the magnet unit makes contact with the frame when it reaches its maximum excursion. Accordingly, the shaker may be operated at higher peak voltages without encountering rattling and noise artefacts which may occur when the shaker bottoms out. This is an important performance parameter for a shaker.

Moreover, the progressively increasing stiffness provided by the suspension that includes the elastomeric material can result in a useful power compression effect wherein a maximal displacement of the magnet unit is limited resulting in a shift upwards in resonance frequency of the shaker at higher peak voltages, thus increasing the vibration energy which may be transmitted to the application.

The use of suspension that includes the elastomeric material in this way to limit the maximal displacement of the magnet unit also means that a high-performance shaker having a smaller form-factor may be more easily implemented wherein the magnet unit is prevented from bottoming out when the frame is small by the damping effects of the suspension, without the need for other costly components to limit movement of the magnet unit.

The other one of the proximal and distal suspensions, i.e. the one of the proximal and distal suspensions other than the suspension that includes the elastomeric material, may be referred to as the “other” suspension herein (in reference to the first aspect of the invention) for brevity.

The shaker may be considered to be at rest when electrical current is not supplied to the voice coil and the magnet unit is not moving. The position of the magnet unit when the shaker is at rest may be referred to as a rest position of the magnet unit.

In use, supplying electrical current to the voice coil will cause the magnet unit to move along the movement axis and become displaced from its rest position, and the amount by which the magnet unit is displaced from its rest position along the movement axis may be referred to as displacement of the magnet unit. Displacement of the magnet unit along the movement axis (from the rest position) may be measured using any fixed location on a rigid part of the magnet unit.

A maximum negative displacement of the magnet unit may be taken as a maximum distance that the magnet unit can move from its rest position, along the movement axis in a first direction, until the magnet unit comes in contact with the frame or voice coil. A maximum positive displacement of the magnet unit may be the maximum distance that the magnet unit can move from its rest position, in a second direction along the movement axis (opposite to the first direction along the movement axis). The first direction may be referred to as the negative direction herein. The second direction may be referred to as the positive direction herein.

The application may be any object or apparatus to which the shaker can be attached via the application attachment surface on the frame. In some examples, the application may be a car seat.

Stiffness is a well-understood parameter of a suspension, and may be measured by applying a controlled incremental and decremental force to the suspension element and measuring the displacement for any force applied. Techniques for measuring stiffness are well-known. In the context of the present invention, stiffness may be measured in relation to displacement of the magnet unit from its rest position (the position in which the magnet unit is at when the shaker is at rest) since as shown in e.g. FIGS. 18a and 18b, stiffness tends to increase with displacement from a rest position.

The suspension that includes the elastomeric material may be made (entirely) of the elastomeric material. For example, the suspension that includes the elastomeric material may be made of rubber (for example, NBR, NR, EPDM). In other examples, the suspension that includes the elastomeric material may be made of a textile which includes elastic material that is configured to stretch when the magnet unit moves relative to the voice coil.

The suspension that includes the elastomeric material may in some examples be a composite element, including both elastomeric and non-elastomeric materials.

The suspension that includes the elastomeric material may be configured such that a restoring force (in Newtons) provided by the suspension that includes the elastomeric material increases substantially in linear proportion to the displacement of the magnet unit (from the rest position of the magnet unit) along a region of displacement of the magnet unit (from the rest position of the magnet unit). In other words, the suspension that includes the elastomeric material may be configured to obey Hooke's law along a region of displacement of the magnet unit.

The suspension that includes the elastomeric material may be configured such that the restoring force (in Newtons) provided by the suspension that includes the elastomeric material increases substantially in linear proportion to the displacement of the magnet unit (from the rest position of the magnet unit) between a maximum negative displacement and a maximum positive displacement of the magnet unit.

The suspension that includes the elastomeric material may be configured such that the stiffness of the suspension that includes the elastomeric material when the magnet unit is at the maximum positive displacement is at least two times the stiffness of the suspension that includes the elastomeric material when the magnet unit is in the rest position. The suspension that includes the elastomeric material may be configured such that the stiffness of the suspension that includes the elastomeric material when the magnet unit is at the maximum negative displacement is at least two times the stiffness of the suspension that includes the elastomeric material when the magnet unit is in the rest position. In this way, an adequate restoring force may be provided by the suspension that includes the elastomeric material when the magnet unit has reached a maximum excursion, thereby reducing the occurrence of bottoming out of the shaker and the production of undesirable noise.

The suspension that includes the elastomeric material may be annular, and positioned such that the suspension that includes the elastomeric material extends circumferentially around the magnet unit.

The suspension that includes the elastomeric material may be a flat disc extending circumferentially around the magnet unit.

In other examples, the suspension that includes the elastomeric material may be a roll suspension. For example, the suspension that includes the elastomeric material may extend circumferentially around the magnet unit, and may include a curved (e.g. semi-circular) roll when viewed in cross-section in a plane containing the movement axis. In some examples, the suspension that includes the elastomeric material may include two concentric flat sections joined by a curved (e.g. semi-circular) section forming a roll when viewed in cross-section in a plane containing the movement axis. The suspension that includes the elastomeric material may have a single roll geometry. The roll suspension is preferably shallow. For example, a maximum extent of the roll suspension, as measured along the movement axis, may be no more than 40%, preferably no more than 30%, preferably no more than 20% of a width of an unclamped portion of the roll suspension as measured in a direction perpendicular to the movement axis in a plane containing the movement axis (on a same side of the movement axis) when the shaker is at rest. The width of the unclamped portion of the roll suspension may extend from the magnet unit to an inner surface of the frame corresponding to an outer periphery of the unclamped portion of the suspension.

By including a roll geometry in the suspension that includes the elastomeric material, manufacturing tolerances may be increased in the positioning of the magnet unit in the shaker. Moreover, the roll geometry may lower stresses experienced by the connection between the suspension and the magnet unit and the connection between the suspension and the frame (which typically includes a glue which is applied around the outer perimeter of the suspension). Introducing a roll geometry may introduce asymmetries and/or non-linearities in the stiffness provided by the suspension that includes the elastomeric material (as the magnet unit moves in the first (negative) direction from its rest position, compared with as it moves in the second (positive) direction from its rest position. However, by including a roll geometry which is shallow, the suspension that includes the elastomeric material is more likely to resiliently stretch within a maximum excursion range of the magnet unit such that the stiffness of the suspension increases as the magnet unit moves along the movement axis away from the rest position compared with if a deeper roll geometry is used.

The roll geometry of the suspension that includes the elastomeric material may be configured to meet a stiffness criterion as defined herein, e.g. such that the stiffness of the suspension that includes the elastomeric material when the magnet unit is at the maximum positive displacement is at least two times the stiffness of the suspension that includes the elastomeric material when the magnet unit is in the rest position and/or the stiffness of the suspension that includes the elastomeric material when the magnet unit is at the maximum negative displacement is at least two times the stiffness of the suspension that includes the elastomeric material when the magnet unit is in the rest position.

The suspension that includes the elastomeric material may be attached to the magnet unit via an attachment ring. An attachment ring may be helpful to facilitate attachment of the suspension that includes the elastomeric material to the magnet unit. In particular, the attachment ring may act to stiffen the part of this suspension that it is attached to which may make handling of this suspension and fitting of this suspension to the magnet unit easier during assembly of the loudspeaker.

The attachment ring may be attached to the suspension that includes the elastomeric material at an inner periphery of the suspension that includes the elastomeric material and may extend circumferentially around the magnet unit. The attachment ring may be formed of a plastic (for example PC, PC-ABS, PP). The attachment ring may be attached to the suspension that includes the elastomeric material and the magnet unit, e.g., by glue. In other examples, the attachment ring may be over-moulded on the magnet unit and attached to the suspension that includes the elastomeric material by glue. In this way, attachment of the suspension that includes the elastomeric material to the magnet unit may be simplified and cheaper because a more conventional glue may be used to attach the attachment ring to the magnet unit instead of a glue designed to bond with the elastomeric material included in the suspension that includes the elastomeric material.

In an alternative example, the suspension that includes the elastomeric material may be attached directly to the magnet unit. For example, if the suspension that includes the elastomeric material is made of rubber, the suspension that includes the elastomeric material may be attached directly to the magnet unit by vulcanization of the rubber. In this way, attachment of this suspension to the magnet unit may be simplified since a glue designed to operate on the elastomeric material included in this suspension is not needed.

In some examples the suspension that includes the elastomeric material may be formed from an air impermeable material, wherein the suspension that includes the elastomeric material, together with the frame, is configured to contain an air volume for resisting movement of the magnet unit relative to the movement axis when the shaker is activated. In such examples, the suspension that includes the elastomeric material is preferably the proximal suspension, since it is more convenient for the proximal suspension to contain the air volume.

In other examples, the suspension that includes the elastomeric material may be formed from an air permeable material and/or include apertures or slots.

The other suspension may be a metal suspension, i.e. it may be made of metal. A metal suspension can, by giving it a suitable geometry, be configured to dominate or not dominate the overall stiffness of the suspension arrangement, according to design requirements, thereby helping to achieve a stiffness requirement as described herein.

The metal suspension may be formed of sheet metal. In some examples, the thickness of the sheet metal may be 1 mm or less. The metal suspension may be a leaf spring configured to bend when the magnet unit moves relative to the voice coil along the movement axis.

The metal suspension may have one or more cut-outs formed therein, to facilitate suitable behaviour. The one or more cut-outs may have a spiral shape.

The metal suspension may be annular and positioned such that the metal suspension extends circumferentially around the magnet unit.

Accordingly, the metal suspension may include one or more (preferably more than one, preferably at least three) attachment tabs on an outer periphery thereof, wherein the one or more attachment tabs facilitate a mechanical attachment of the distal suspension to the frame. More preferably, the frame includes one or more slots, the/each slot corresponding to a respective attachment tab on an outer periphery of the metal suspension, wherein the one or more attachment tabs facilitate a mechanical attachment of the distal suspension to the frame via a bayonet fitting in which the attachment tabs engage with a respective slot in the frame. This helps facilitate accurate alignment of the metal suspension when attaching this metal suspension to the frame.

In other examples, the other suspension may be made of plastic configured to bend when the magnet unit moves relative to the voice coil along the movement axis. In other examples, the other suspension may be made of rubber or textile. In some examples, this rubber or textile suspension may have a higher (or lower) stiffness than the suspension that includes the elastomeric material, e.g. according to design requirements.

Preferably, the suspension that includes the elastomeric material is the proximal suspension, and the other (e.g. metal) suspension is the distal suspension. This can be helpful for ease of manufacturing in forming the shaker from its constituent parts, particularly when the frame includes a main frame and a subframe (see below). Moreover, the distal suspension may be exposed depending on how the shaker is to be mounted to the application, and thus it is an advantage to have the other suspension (which may be non-elastomeric, and hence may be more durable, and may, for instance, be made of metal—see above) to be exposed, rather than the suspension that includes the elastomeric material. Having the suspension that includes the elastomeric material as the proximal suspension is particularly preferred when the other suspension is a metal suspension (since metal is particularly durable).

But it is also possible in some examples for the suspension that includes the elastomeric material to be the distal suspension and the other suspension to be the proximal suspension.

Preferably one of the proximal and distal suspensions has a stiffness K₁, and the other of the proximal and distal suspensions has a stiffness K₂, wherein K₂>K₁ when the shaker is at rest, i.e. the stiffness K₂ of one of the proximal and distal suspensions when the shaker is at rest is larger than the stiffness K₁ of the other of the proximal and distal suspensions when the shaker is at rest.

In such examples, the one of the proximal and distal suspensions having the stiffness K₂ may be referred to herein as the “primary” or “dominant” suspension and the one of the proximal and distal suspensions having the stiffness K₁ may be referred to as the secondary or “non-dominant” suspension.

The ratio K₁/K₂ is preferably 0.4 or less when the shaker is at rest. Advantages of such a configuration are described in the extracts GB2108925.5 provided in the Annex below. Any associated feature as described in the Annex (e.g. in relation to the suspension having the stiffness K₁ and/or the suspension having the stiffness K₂) below may optionally be used in combination with any aspect of the present invention, except where this is clearly impermissible or expressly avoided.

The stiffness K₁ may be 0.1 N/mm or higher, more preferably 0.2 N/mm or higher, more preferably 0.4 N/mm or higher, when the shaker is at rest.

The stiffness K₁ may be 20 N/mm or lower, more preferably 10 N/mm or lower, when the shaker is at rest.

In some examples, K₁ may be in the range 0.4 N/mm to 10 N/mm when the shaker is at rest.

In some examples, K₁ may be in the range 2 N/mm to 50 N/mm, when the shaker is at rest.

The stiffness K₂ may be 1 N/mm or higher, more preferably 2 N/mm or higher, when the shaker is at rest.

The stiffness K₂ may be 100 N/mm or lower, more preferably 50 N/mm or lower, when the shaker is at rest.

In some examples, K₂ may be in the range 1 N/mm to 100 N/mm, when the shaker is at rest.

The magnet unit may have a mass of 40 g or more.

The suspension that has the stiffness K₂ may be annular and positioned such that the suspension that has the stiffness K₂ extends circumferentially around the magnet unit.

The ratio K₁/K₂ may be 0.35 or less when the shaker is at rest. The ratio K₁/K₂ may be 0.3 or less, or even 0.25 or less when the shaker is at rest. The lower the ratio K₁/K₂ when the shaker is at rest, the more dominant the suspension that has the stiffness K₂ is in providing stiffness to the suspension arrangement.

In some examples, the proximal suspension may have the stiffness K₁, and the distal suspension may have the stiffness K₂. In other examples, the proximal suspension may have the stiffness K₂, and the distal suspension may have the stiffness K₁.

Preferably, the suspension that includes the elastomeric material has the stiffness K₁ (when the shaker is at rest) and the other (e.g. metal) suspension has the stiffness K₂, when the shaker is at rest.

Preferably, the suspension has the stiffness K₂ (when the shaker is at rest) is a metal suspension. The present inventors have found that the combination of using a metal suspension as the suspension having stiffness K₂ and an elastic suspension as the suspension having stiffness K₁ is particularly advantageous in providing the beneficial effects noted above, as this combination is able to provide a shaker that is stable against rocking motion and easy to manufacture. In addition, this combination provides a shaker that has improved resonant frequency stability over time.

For avoidance of any doubt, the suspension that includes the elastomeric material may have the stiffness K₂ (when the shaker is at rest), and the other (e.g. metal) suspension may have the stiffness K₁ (when the shaker is at rest).

Furthermore, it is also possible that in some examples the proximal and distal suspensions have a same stiffness when the shaker is at rest (though it is generally preferred for there to be a dominant and a non-dominant suspension as described above, for reasons that can e.g. be understood from the Annex enclosed herewith).

The shaker may have a resonant frequency Fₛ. The resonant frequency Fₛ may be taken as the frequency at which a displacement of the magnet unit along the movement axis is at a maximum for a given RMS excitation input voltage used with the shaker.

Fₛ may be 30 Hz or higher, more preferably 40 Hz or higher.

Fₛ may be 200 Hz or lower, more preferably 100 Hz or lower, more preferably 70 Hz or lower.

In some examples, Fₛ may be in the range 30 Hz to 200 Hz, e.g., in the range 30 Hz to 70 Hz. The magnet unit may include a U-yoke, having a U shape when viewed in cross section, wherein the U-yoke has a base end corresponding to the base of the U shape, and an open end corresponding to the open end of the U shape. Preferably, the U-yoke is mounted in the shaker with the base end of the U-yoke further from the voice coil attachment surface than the open end of the U-yoke. In other examples, the magnet unit may include a T-yoke, having an inverted T shape when viewed in cross section.

Preferably, the U-yoke includes an open-end attachment surface at the open-end of the U-yoke, wherein an inner periphery of the proximal suspension which interconnects the frame and the magnet unit is attached to the magnet unit at the open end attachment surface of the magnet unit.

The U-yoke may include a shoulder at its open end to provide the open-end attachment surface. The shoulder may take the form of an annular indentation formed in the open end of the U-yoke.

Preferably, the U-yoke includes a base end attachment surface at the base end of the U-yoke, wherein an inner periphery of the distal suspension which interconnects the frame and the magnet unit is attached to the magnet unit at the base end attachment surface of the magnet unit.

The U-yoke may include a shoulder at its base end to provide the base end attachment surface. The shoulder may take the form of an annular indentation formed in the base end of the U-yoke.

The shaker may be divided into a proximal side and a distal side by a mid-plane which is perpendicular to the movement axis and which passes through (e.g. a center of) the voice coil windings when the shaker is at rest, wherein the proximal side of the shaker is on the side of the mid-plane that includes the voice coil former attachment surface, and wherein the distal side of the shaker is on the other side of the mid-plane from the proximal side.

For avoidance of any doubt, the mid-plane could be at any location along the movement axis, as long as it passes through the voice coil and is not located at the ends of the shaker.

Preferably, the proximal suspension is located on the proximal side of the shaker, and the distal suspension is located on the distal side of the shaker. This helps inhibit rocking motion during use of the shaker. The base end attachment surface of the U-yoke may be located on the distal side of the shaker and the open end attachment surface of the U-yoke may be located on the proximal side of the shaker. However, other arrangements are possible.

The application attachment surface may be on the proximal side of the mid-plane or on the distal side of the mid-plane, or indeed may lie on the mid-plane, since the application attachment surface will in general vary depending on the application and design requirements.

The frame may include a main frame and a subframe which are attached together, wherein the main frame includes the application attachment surface.

The main frame may include at least one distal suspension attachment surface for attaching the distal suspension thereto. The at least one distal suspension attachment surface may be provided by one or more slots in the main frame, the/each slot corresponding to a respective attachment tab on an outer periphery of the distal suspension, wherein the one or more attachment tabs facilitate a mechanical attachment of the distal suspension to the main frame via a bayonet fitting in which the attachment tabs engage with a respective slot in the frame when attaching this suspension to the frame. In this arrangement, the distal suspension preferably is the other (e.g. metal) suspension (rather than the suspension that includes the elastomeric material).

The subframe may include the voice coil former attachment surface.

The main frame and/or subframe may include at least one proximal suspension attachment surface for attaching an outer periphery of the proximal suspension thereto. In some embodiments, both the main frame and subframe may each include at least one proximal suspension attachment surface for attaching an outer periphery the proximal suspension thereto, wherein the outer periphery of the proximal suspension is sandwiched between at least one proximal suspension attachment surface of the main frame and at least one proximal suspension attachment surface of the subframe.

A dustcap may be part of the subframe, e.g., the dustcap may be attached to another frame element to form the subframe. The dustcap may be configured to inhibit dust from entering a U-yoke of the magnet unit.

The voice coil may include at least two layers, preferably at least four layers (i.e., a wire forming the voice coil may be wrapped around the voice coil former such that it forms at least two layers of wire coil, preferably at least four layers), since this can aid performance of the shaker.

The air gap may extend around the movement axis.

The frame (preferably the subframe) may include one or more channels, wherein each channel is for guiding a respective wire from the voice coil out of the shaker.

One of the proximal and distal suspensions may be air impermeable, wherein the air impermeable suspension, together with the frame, is configured to contain an air volume for resisting movement of the magnet unit along the movement axis when the shaker is activated. Advantages of such an arrangement are discussed in connection with the third aspect of the invention, below.

The shaker according to the first aspect may include any one or more features described in connection with the third aspect of the invention (e.g. in relation to the air volume, the air impermeable suspension, one or more vent holes and/or material covering the one or more vent holes).

For example, the air impermeable suspension may be the proximal suspension, and the other suspension may be the distal suspension. In such examples, the air impermeable suspension may form a seal that substantially prevents airflow therethrough.

In other examples, the air impermeable suspension may be the distal suspension, and the other suspension may be the proximal suspension. In such examples, the air impermeable distal suspension may form a seal that substantially prevents airflow therethrough.

For example, the air impermeable suspension, and the frame, may be configured to provide a predetermined damping effect on the movement of the magnet unit. The air impermeable suspension, and the frame, may be configured to provide a desired resonant frequency of the shaker Fₛ.

For example, the frame and/or magnet unit may include one or more vent holes for allowing air to escape from and pass into the air volume, which may optionally be covered by a material having a specific airflow resistance. In this way, controlled airflow in and out of the air volume can be provided to dampen movement of the magnet unit. The present inventor has found that by using vent holes and optional covering material to dampen movement of the magnet unit, the resonant frequency of the shaker may be decreased compared to if the air volume is fully sealed.

For example, the/each vent hole may (respectively) be covered by a material having a specific airflow resistance, e.g. so as to provide a predetermined resistance to the air escaping from and passing into the air volume. For example, the material covering the vent holes may be a textile, felt, a foam element, paper or any other suitable microperforated material having the specific airflow resistance. The specific airflow resistance of the material covering the/each vent hole may be in the range 0 to 5000 Pa·s/m, more preferably in the range 50 to 2500 Pa·s/m. This may help provide a controlled amount of damping to the magnet unit and a desired resonant frequency for the shaker. This effect is described in more detail below in relation to FIGS. 22 and 23.

For example, the specific airflow resistance of the material covering the/each vent hole may be 0 to 5000 Pa·s/m, more preferably 50 Pa·s/m to 2500 Pa·s/m.

For example, the volume of the air volume may be in the range 5 cm³ to 30 cm³ more preferably 10 cm³ to 20 cm³.

For example, the surface area of a part of the magnet unit which is configured to move inside the air volume may be in the range 3 cm² to 50 cm², more preferably 8 cm² to 20 cm².

In a second aspect of the present invention, the present invention may provide an apparatus including:
a shaker according to the first aspect;
an application, wherein the shaker is attached to the application via the application attachment surface.

The application may be a seat, e.g. a car seat. In examples, the shaker may be attached to the seat (e.g. car seat) via a frame of the car seat, via foam in the seat, or via a stiff panel in the seat, wherein the stiff panel may form a soundboard for the shaker.

The application may be an acoustic panel, configured to produce sound when the shaker is activated by supplying electrical current to the voice coil. As is well-known in the art, an acoustic panel would typically have a high stiffness, and would be suitably damped for the purpose of making sound when vibrated at an acoustic frequency.

In a third aspect of the present invention, the present invention may provide: A shaker for transmitting vibrations to an application, the shaker having:
a frame, including an application attachment surface for attaching the shaker to the application;
a magnet unit configured to provide a magnetic field in an air gap;
a coil assembly including a voice coil mounted to a voice coil former, wherein the voice coil former is attached to the frame at a voice coil former attachment surface on the frame, wherein the voice coil former is configured to position the voice coil in the air gap, when the shaker is at rest;
wherein the magnet unit is configured to move relative to the voice coil along a movement axis of the shaker when the shaker is activated by supplying electrical current to the voice coil;
wherein the magnet unit is suspended from the frame by a suspension arrangement that includes a proximal suspension which interconnects the frame and the magnet unit and a distal suspension which interconnects the frame and the magnet unit, wherein the proximal suspension is closer to the voice coil former attachment surface on the frame than the distal suspension when the shaker is at rest;
wherein one of the proximal and distal suspensions is air impermeable, wherein the air impermeable suspension, together with the frame, is configured to contain an air volume for resisting movement of the magnet unit along the movement axis when the shaker is activated.

In this way, the air volume may provide protection for the proximal and distal suspensions by alleviating the stresses on the suspensions reducing fatigue of the suspensions and increasing the durability of the shaker.

In addition, the air volume may be considered as providing an additional stiffness to the stiffness already provided by the proximal and distal suspensions. The stiffness introduced by air volume can reduce instances of the shaker bottoming out, i.e. instances in which the magnet unit makes contact with the frame or voice coil when it reaches its maximum excursion. Accordingly, the shaker may be operated at higher peak voltages without encountering rattling and noise artefacts which may occur when the shaker bottoms out.

In addition, the amount of stiffness provided by the air volume, and therefore the resonant frequency of the shaker, may be adjusted by changing the size and other characteristics of the air volume without the need to re-design or replace the suspensions or other moving components for new applications. For example, as described in detail below, vent holes covered by a material having a specific airflow resistance may be included in the frame and/or magnet unit surrounding the air volume to dampen movement of the magnet unit, for further adjusting the resonant frequency of the shaker.

By having one of the proximal and distal suspensions as an air impermeable suspension, the air inside the air volume may be compressed when the air impermeable suspension and the magnet unit move towards the air volume. Thus, the compressed air in the air volume may resist movement of the magnet in a first direction, towards the air volume. The air volume may also provide a negative pressure (i.e. a suctioning force) when the air impermeable suspension and the magnet unit move away from the air volume in a second direction. Thus, the negative pressure resists movement of the magnet in a second direction. In this way, the air volume may act as an air cushion and perform as a third suspension to resist movement of the magnet unit as the magnet unit moves in both first and second directions.

For avoidance of any doubt, the air volume may be further contained by the magnet unit (in addition to the frame and air permeable suspension).

The other one of the proximal and distal suspensions, i.e. the one of the proximal and distal suspensions other than the air impermeable suspension, may be referred to as the “other” suspension herein (in reference to the third aspect of the invention) for brevity.

The other suspension may be a metal suspension, i.e. it may be made of metal. A metal suspension can, by giving it a suitable geometry, be configured to dominate or not dominate the overall stiffness of the suspension arrangement, according to design requirements, thereby helping to achieve a stiffness requirement as described herein.

The metal suspension may be formed of sheet metal. In some examples, the thickness of the sheet metal may be 1 mm or less. The metal suspension may be a leaf spring configured to bend when the magnet unit moves relative to the voice coil along the movement axis.

The metal suspension may have one or more cut-outs formed therein, to facilitate suitable behaviour. The one or more cut-outs may have a spiral shape.

The metal suspension may be annular and positioned such that the metal suspension extends circumferentially around the magnet unit.

Accordingly, the metal suspension may include one or more (preferably more than one, preferably at least three) attachment tabs on an outer periphery thereof, wherein the one or more attachment tabs facilitate a mechanical attachment of the distal suspension to the frame. More preferably, the frame includes one or more slots, the/each slot corresponding to a respective attachment tab on an outer periphery of the metal suspension, wherein the one or more attachment tabs facilitate a mechanical attachment of the distal suspension to the frame via a bayonet fitting in which the attachment tabs engage with a respective slot in the frame. This helps facilitate accurate alignment of the metal suspension when attaching this metal suspension to the frame.

In other examples, the other suspension may be made of plastic configured to bend when the magnet unit moves relative to the voice coil along the movement axis. In other examples, the other suspension may be made of rubber or textile. In some examples, this rubber or textile suspension may have a higher (or lower) stiffness than the air impermeable suspension, e.g. according to design requirements.

In some examples, the air impermeable suspension may be the proximal suspension, and the other suspension may be the distal suspension. In such examples, the air impermeable suspension may form a seal that substantially prevents airflow therethrough.

In other examples, the air impermeable suspension may be the distal suspension, and the other suspension may be the proximal suspension. In such examples, the air impermeable distal suspension may form a seal that substantially prevents airflow therethrough.

The air impermeable suspension, and the frame, may be configured to provide a predetermined damping effect on the movement of the magnet unit. The air impermeable suspension, and the frame, may be configured to provide a desired resonant frequency of the shaker Fₛ.

For example, the air impermeable suspension, and the frame, may be configured to provide a desired resonant frequency of the shaker Fₛ by appropriate sizing of the air volume. In this way, the compliance of the air volume (which is equal to the reciprocal of the stiffness of the air volume) may be increased or decreased to adjust the maximum excursion of the magnet unit and the resonant frequency of the shaker.

Therefore, the stiffness of the air volume which helps to resist movement of the magnet unit may be adjusted by adjusting the total shape of the magnet unit and hence the surface area of a part of the magnet unit which is configured to move inside the air volume.

The frame and/or magnet unit may include one or more vent holes for allowing air to escape from and pass into the air volume, wherein the/each vent hole may optionally be covered by a material having a specific airflow resistance. In this way, controlled airflow in and out of the air volume can be provided to dampen movement of the magnet unit. The present inventor has found that by using vent holes and optional covering material to dampen movement of the magnet unit, the resonant frequency of the shaker may be decreased compared to if the air volume is fully sealed.

The/each vent hole may (respectively) be covered by a material having a specific airflow resistance, e.g. so as to provide a predetermined resistance to the air escaping from and passing into the air volume. For example, the material covering the vent holes may be a textile, felt, a foam element, paper or any other suitable microperforated material having the specific airflow resistance. The specific airflow resistance of the material covering the/each vent hole may be in the range 0 to 5000 Pa·s/m, more preferably in the range 50 to 2500 Pa·s/m. This may help provide a controlled amount of damping to the magnet unit and a desired resonant frequency for the shaker. This effect is described in more detail below in relation to FIGS. 22 and 23.

For avoidance of any doubt, if there are multiple vent holes, each vent hole need not be covered by the same material, or same piece of material. For example, different vent holes may be covered by a different materials having different specific airflow resistances. However, preferably each vent hole is covered (respectively) by a material having a specific airflow resistance in the range 0 to 5000 Pa·s/m, more preferably in the range 50 to 2500 Pa·s/m.

The air impermeable suspension, the frame, and (if included, the material covering the one or more vent holes), may be configured to provide a predetermined damping effect and/or a desired resonant frequency, e.g., by varying the size or number of the one or more vent holes provided in the frame and/or magnet unit, and/or by varying the material covering the vent holes, e.g., as needed to meet one or more design requirements.

For example, to reduce the amount of damping provided by the air volume, larger or more venting holes may be included to reduce the restriction of air passing into and out of the air volume. To increase the amount of damping fewer or smaller venting holes may be provided to restrict the passage of air into and out of the air volume. In some examples, the vent holes may comprise valves and the shaker may be tuned by opening or closing the valves.

In other examples, the amount of damping provided by the air volume may be increased by the specific airflow resistance of the material covering the venting holes to restrict the passage of air into and out of the air volume. The amount of damping provided by the air volume may be reduced by reducing the specific airflow resistance of the material covering the venting holes to facilitate the passage of air into and out of the air volume.

The one or more vent holes may be provided in a part of the frame (e.g. a subframe) that includes the voice coil former attachment surface. A material having a predetermined specific airflow resistance may be provided in the form of a cover, to cover the one or more vent holes provided in this part of the frame. In this way a sufficient amount of air may be configured to pass into and out of the air volume to provide a desired level of damping to the magnet unit.

Alternatively or additionally, the one or more vent holes may be provided in a side of the frame at a position along the movement axis of the shaker between the voice coil former attachment surface and the air impermeable suspension. The one or more vent holes may be covered by a material having a specific airflow resistance. In some examples, the material may be a foam plug. Positioning the one or more venting holes in a side of the frame can be useful when the shaker is installed in an application which could block airflow in and out of venting holes in the voice coil former attachment surface. Thus, the shaker may be installed in more tightly confined spaces while still achieving a high performance.

In other examples, the one or more vent holes may be provided as an opening in the magnet unit, e.g. leading to a rear of the shaker. The opening in the magnet unit may be covered in a material having a specific airflow resistance to adjust the damping effect of the air volume and the resonant frequency of the shaker. This arrangement may be useful for installing the shaker in applications where airflow may be limited in the region of space around the part of the frame which houses the air volume.

The specific airflow resistance of the material covering the/each vent hole may be 0 to 5000 Pa·s/m, more preferably 50 Pa·s/m to 2000 Pa·s/m.

The volume of the air volume may be in the range 5 cm³ to 30 cm³ more preferably 10 cm³ to 20 cm³.

The surface area of a part of the magnet unit which is configured to move inside the air volume may be in the range 3 cm² to 50 cm², more preferably 8 cm² to 20 cm².

Preferably, one of the proximal and distal suspensions includes an elastomeric material which is configured to resiliently stretch such that the stiffness of the suspension that includes the elastomeric material increases as the magnet unit moves along the movement axis away from the rest position.

If one of the proximal and distal suspensions includes an elastomeric material, the air impermeable suspension is preferably also the suspension that includes an elastomeric material. In such arrangements, the air impermeable suspension is preferably also the proximal suspension. This is a particularly elegant way of incorporating the elastic suspension and air volume into the same shaker. But it is also possible for the other suspension (i.e. the suspension other than the air impermeable suspension) to be the suspension that includes an elastomeric material, and/or for the air impermeable suspension to be the distal suspension.

In examples in which one of the proximal and distal suspensions includes an elastomeric material (e.g. examples in which the air impermeable suspension includes an elastomeric material), any one or more features described above with respect to a shaker according to the first aspect of the invention may be combined with a shaker according to the third aspect of the invention.

For example, the air impermeable suspension may be made (entirely) of an elastomeric material which is air impermeable, e.g. rubber.

For example, the suspension that includes the elastomeric material (which may also be the air impermeable suspension) may be a roll suspension.

Preferably one of the proximal and distal suspensions has a stiffness K₁, and the other of the proximal and distal suspensions has a stiffness K₂, wherein K₂>K₁ when the shaker is at rest, i.e. the stiffness K₂ of one of the proximal and distal suspensions when the shaker is at rest is larger than the stiffness K₁ of the other of the proximal and distal suspensions when the shaker is at rest.

In such examples, the one of the proximal and distal suspensions having the stiffness K₂ may be referred to herein as the “primary” or “dominant” suspension and the one of the proximal and distal suspensions having the stiffness K₁ may be referred to as the secondary or “non-dominant” suspension.

The ratio K₁/K₂ is preferably 0.4 or less when the shaker is at rest. Advantages of such a configuration are described in the extracts GB2108925.5 provided in the Annex below.

In some examples, the air impermeable suspension may have the stiffness K₁ (when the shaker is at rest) and the other (e.g. metal) suspension has the stiffness K₂, when the shaker is at rest. In other examples, the air impermeable suspension may have the stiffness K₂ (when the shaker is at rest) and the other (e.g. metal) suspension has the stiffness K₁, when the shaker is at rest.

Any associated feature as described in connection with the first aspect of the invention or in the Annex below in relation to the suspension having the stiffness K₁ and/or the suspension having the stiffness K₂ may optionally be used in combination with this third aspect of the present invention, except where this is clearly impermissible or expressly avoided.

For example, the stiffness K₁ may be 0.1 N/mm or higher, more preferably 0.2 N/mm or higher, more preferably 0.4 N/mm or higher, when the shaker is at rest.

For example, the stiffness K₁ may be 20 N/mm or lower, more preferably 10 N/mm or lower, when the shaker is at rest.

For example, K₁ may be in the range 0.4 N/mm to 10 N/mm when the shaker is at rest.

For example, K₁ may be in the range 2 N/mm to 50 N/mm, when the shaker is at rest.

For example, the stiffness K₂ may be 1 N/mm or higher, more preferably 2 N/mm or higher, when the shaker is at rest.

For example, the stiffness K₂ may be 100 N/mm or lower, more preferably 50 N/mm or lower, when the shaker is at rest.

For example, K₂ may be in the range 1 N/mm to 100 N/mm, when the shaker is at rest.

For example, the magnet unit may have a mass of 40 g or more.

For example, the suspension that has the stiffness K₂ may be annular and positioned such that the suspension that has the stiffness K₂ extends circumferentially around the magnet unit.

For example, the ratio K₁/K₂ may be 0.35 or less when the shaker is at rest. The ratio K₁/K₂ may be 0.3 or less, or even 0.25 or less when the shaker is at rest. The lower the ratio K₁/K₂ when the shaker is at rest, the more dominant the suspension that has the stiffness K₂ is in providing stiffness to the suspension arrangement.

For example, the proximal suspension may have the stiffness K₁, and the distal suspension may have the stiffness K₂. In other examples, the proximal suspension may have the stiffness K₂, and the distal suspension may have the stiffness K₁.

The present inventors have found that the combination of using a metal suspension as the suspension having stiffness K₂, in combination with using the air impermeable suspension (which preferably also includes an elastic material) as the suspension having stiffness K₁, is particularly advantageous in providing a shaker that is stable against rocking motion, easy to manufacture and has a stable resonant frequency over time.

In a fourth aspect of the present invention, the present invention may provide an apparatus including:
a shaker according to the third aspect;
an application, wherein the shaker is attached to the application via the application attachment surface.

The application may be a seat, e.g. a car seat. In examples, the shaker may be attached to the seat (e.g. car seat) via a frame of the car seat, via foam in the seat, or via a stiff panel in the seat, wherein the stiff panel may form a soundboard for the shaker.

The application may be an acoustic panel, configured to produce sound when the shaker is activated by supplying electrical current to the voice coil. As is well-known in the art, an acoustic panel would typically have a high stiffness, and would be suitably damped for the purpose of making sound when vibrated at an acoustic frequency.

In an additional aspect of the present invention, a method of configuring a shaker according to the third aspect of the invention may be provided.

The method may comprise adjusting the size of the one or more vent holes, number the one or more vent holes, or the type of material covering the one or more vent holes (e.g., in the frame) to provide a predetermined damping effect on the movement of the magnet unit or a desired resonant frequency of the shaker (e.g. so as to meet a criterion described herein, e.g. in relation to the resonant frequency of the shaker).

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 11 shows a cross-section of an example shaker;

FIG. 12 shows a cross-section of another example shaker;

FIG. 13a-13b show a cross-section of another example shaker;

FIG. 14a-14b show an exploded view and a perspective view of another example shaker;

FIG. 15a-15b show an exploded view and a perspective view of another example shaker;

FIG. 16 shows a cross-section of another example shaker; and

FIGS. 17-28 show experimental results.

### DETAILED DESCRIPTION

Aspects and embodiments of the present invention will now be discussed with reference to the accompanying figures. Further aspects and embodiments will be apparent to those skilled in the art. All documents mentioned in this text are incorporated herein by reference.

In the examples that follow, alike features have been given corresponding reference numerals, and corresponding descriptions may apply except where such a description is clearly impermissible or expressly avoided.

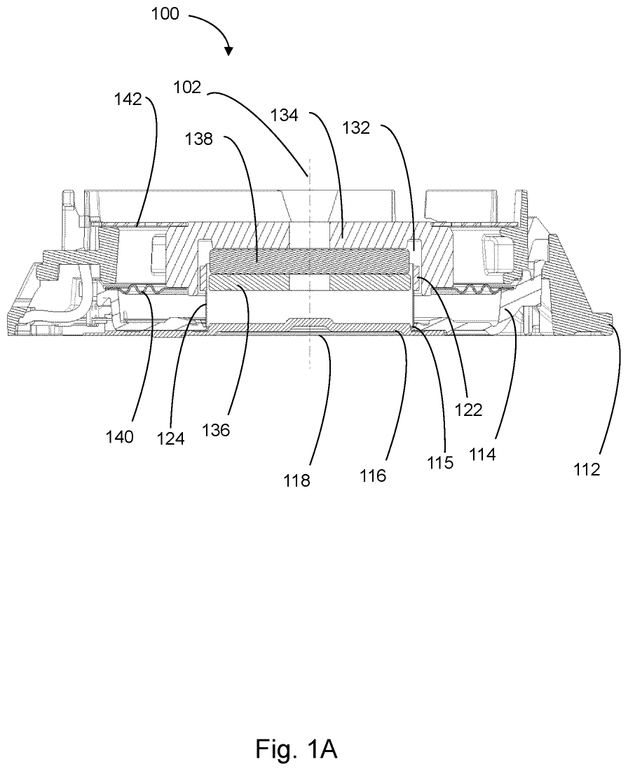

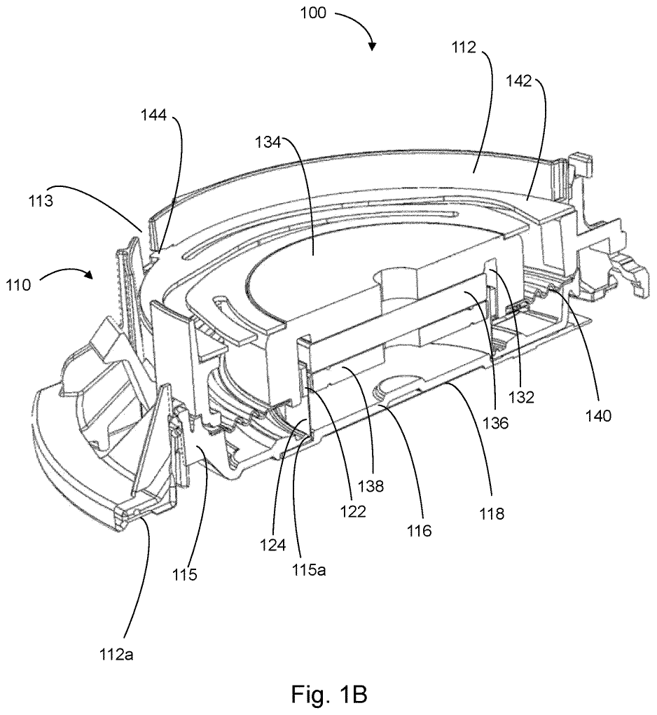

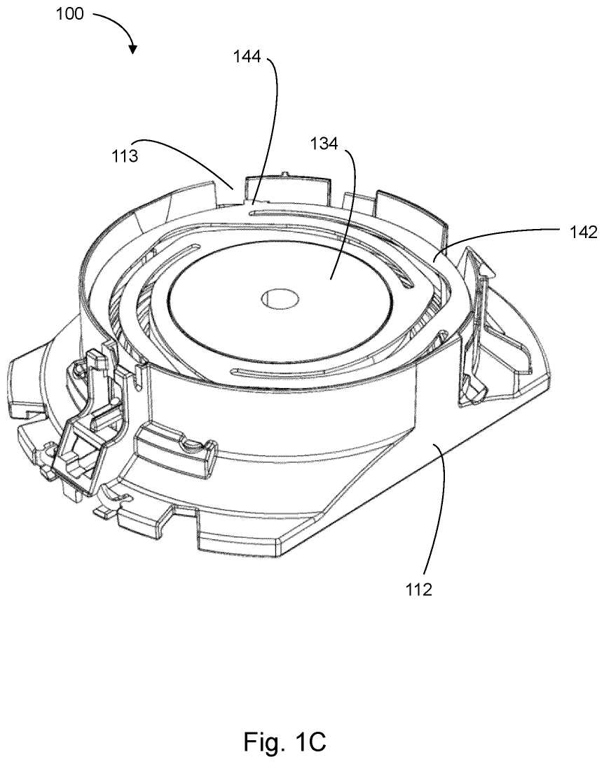

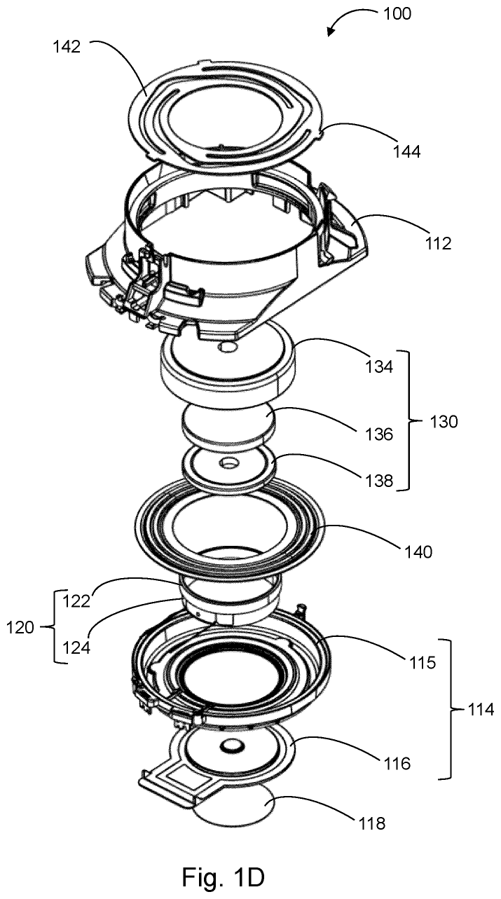

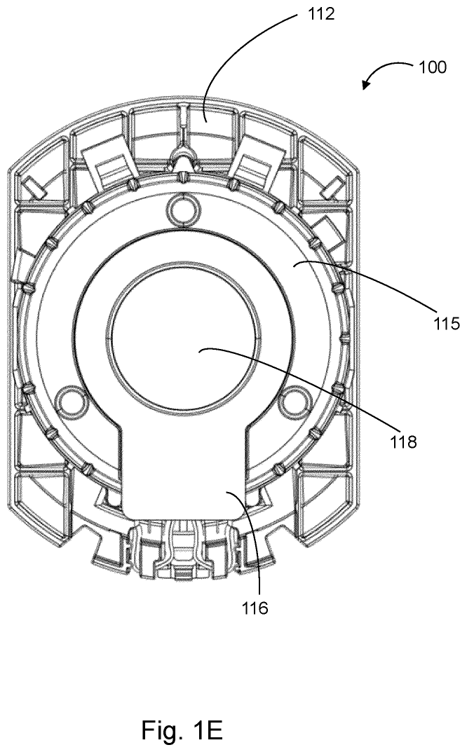

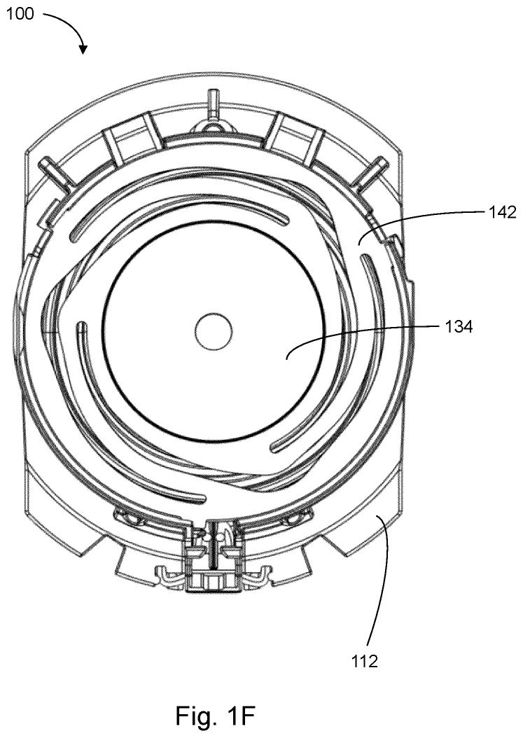

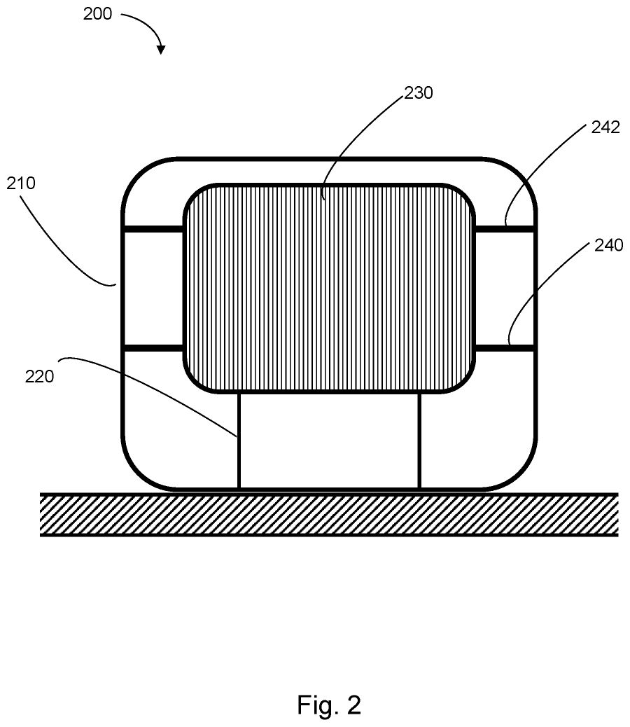

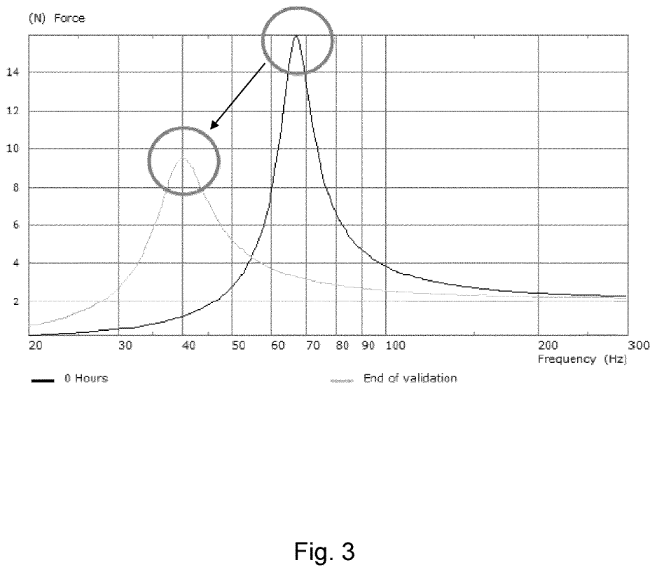

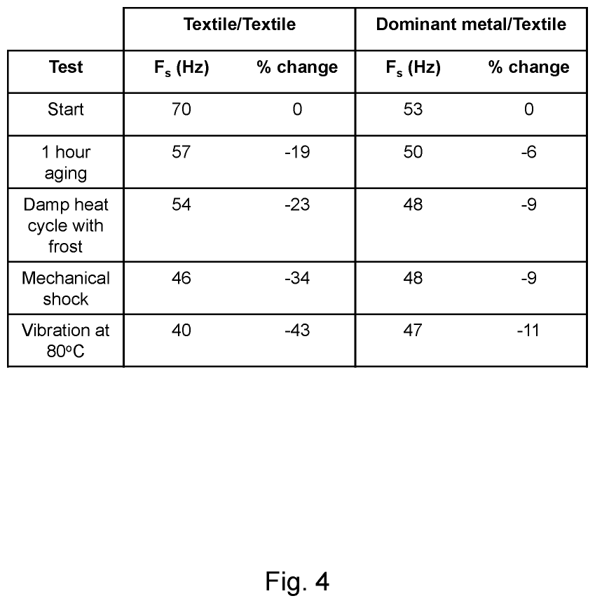

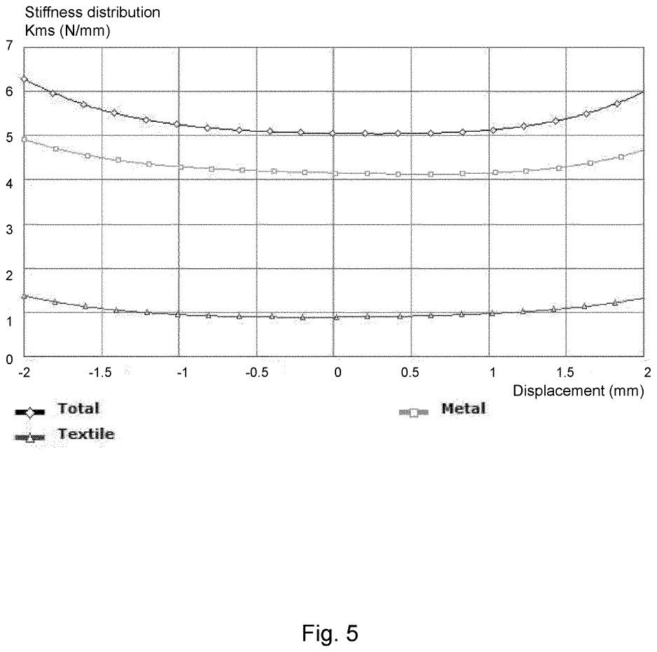

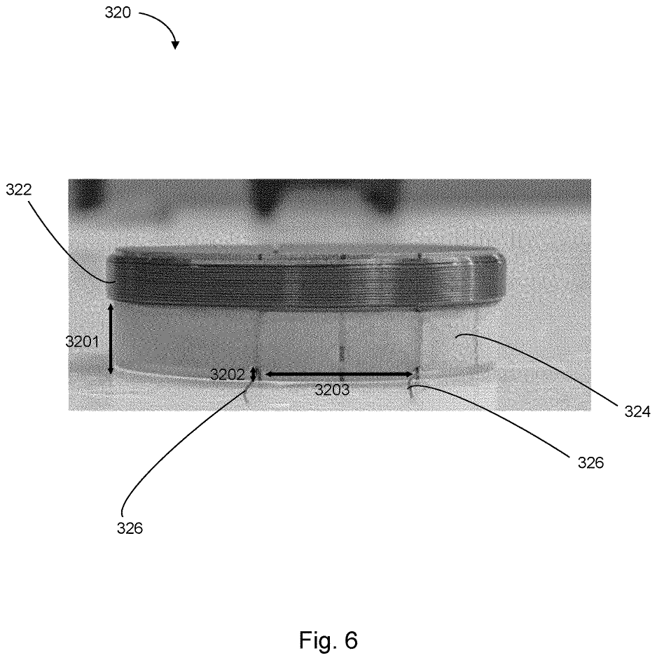

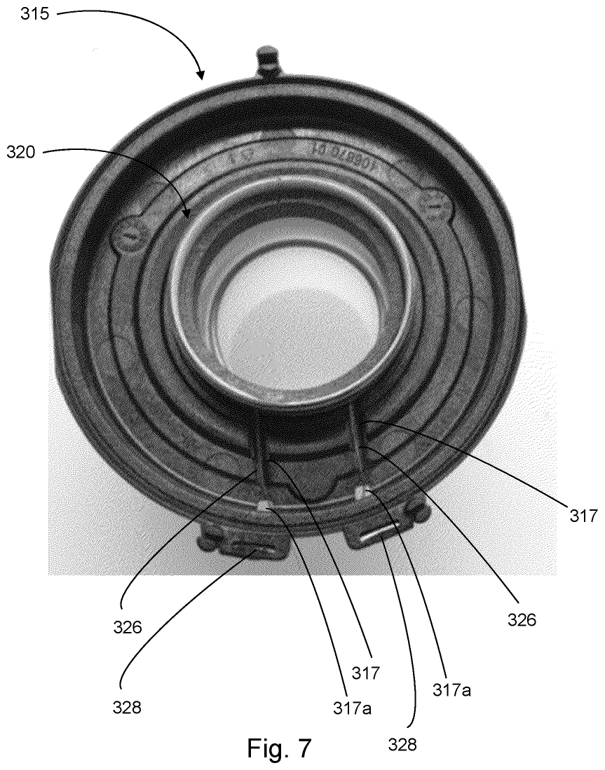

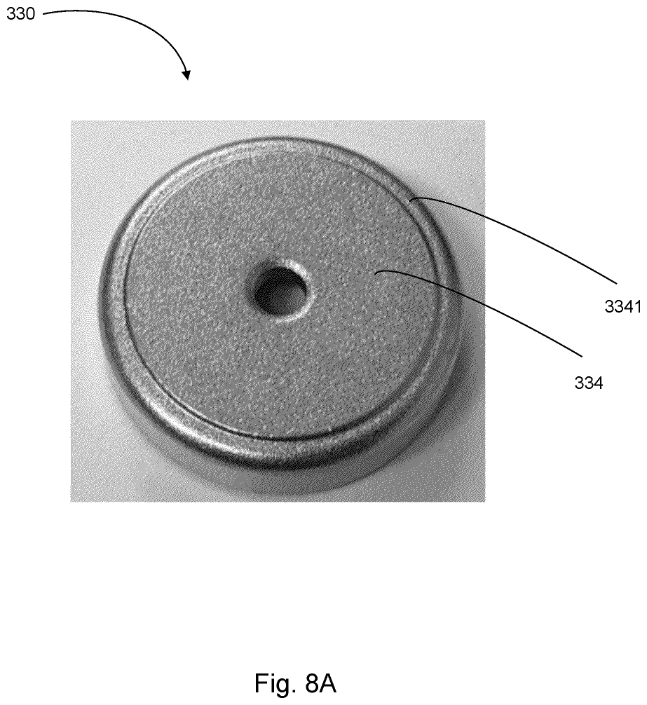

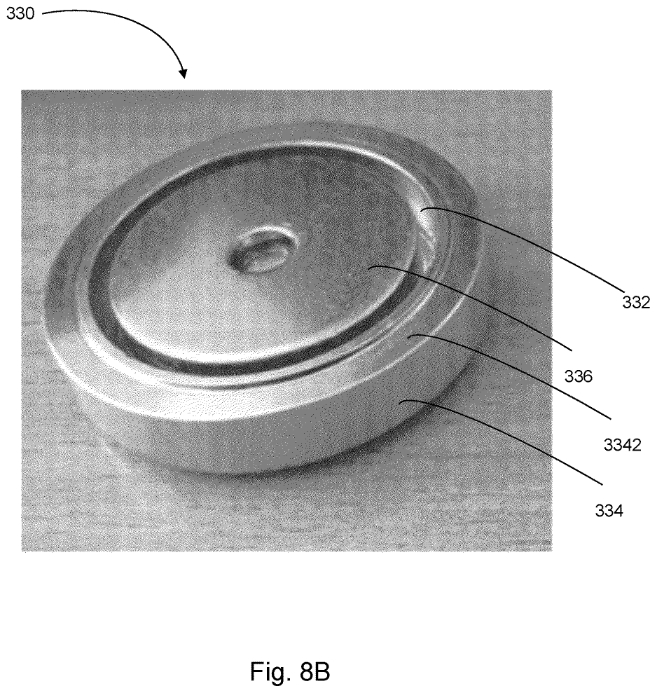

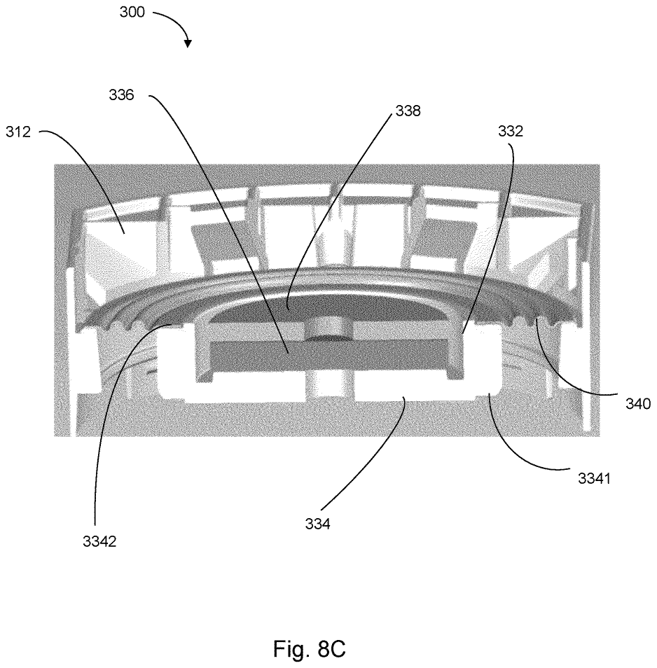

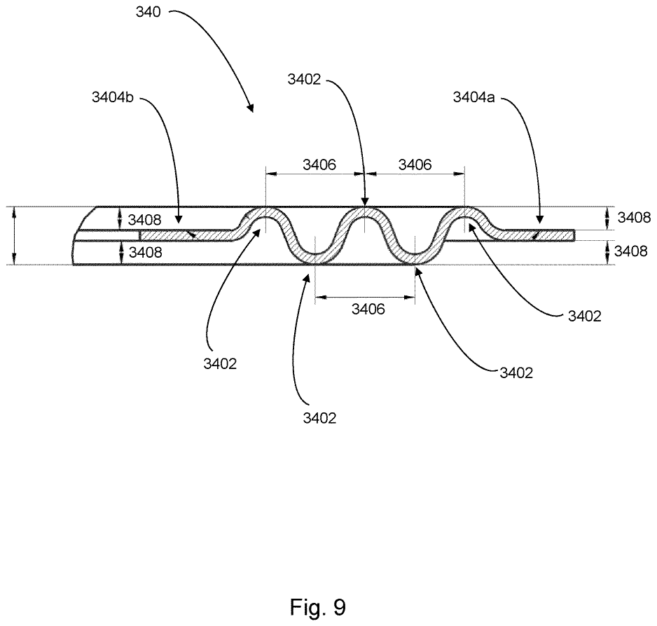

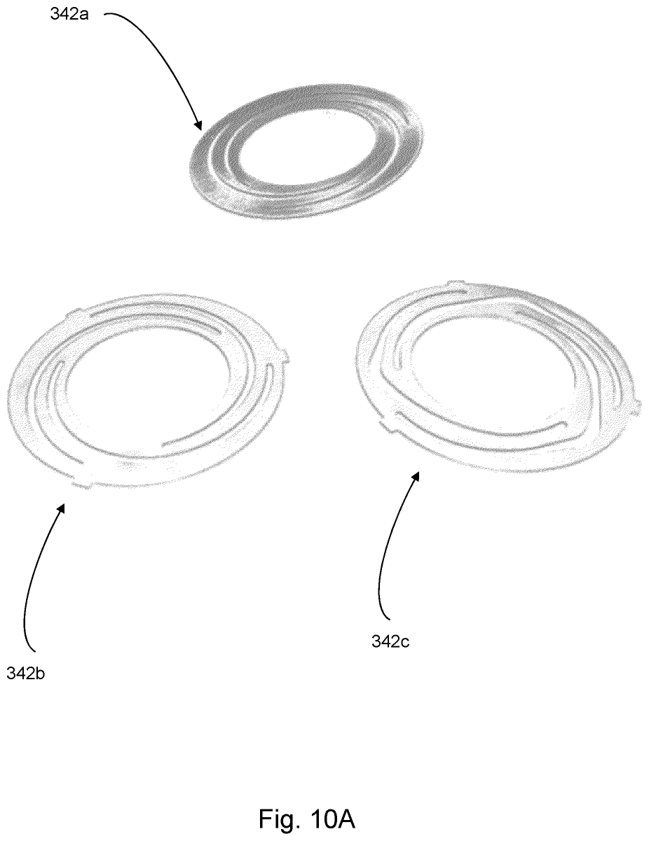

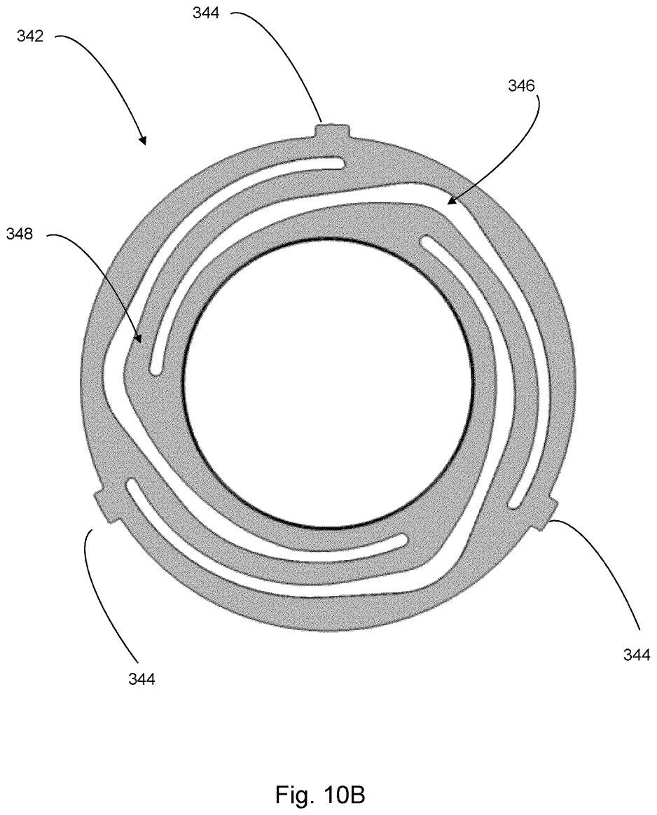

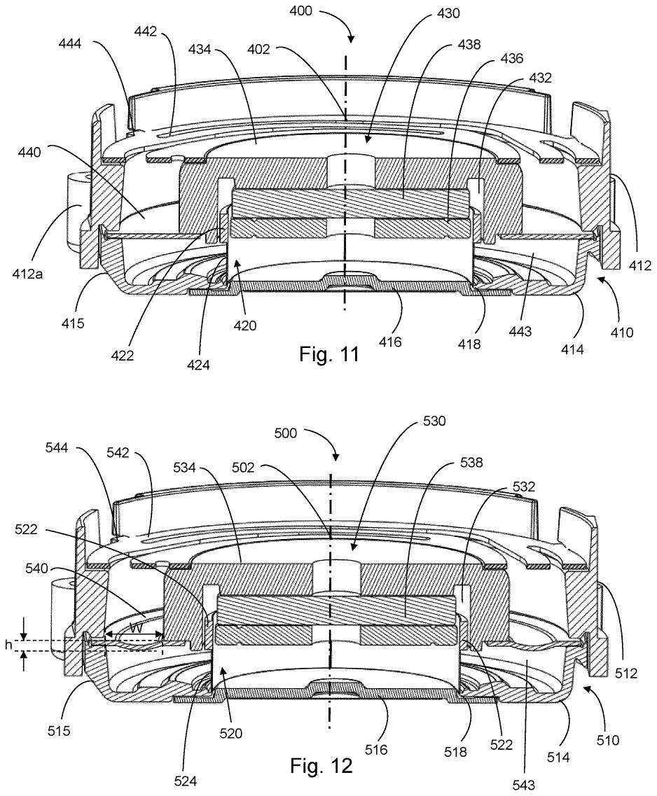

FIG. 11 shows a cross-section of an example shaker 400 for transmitting vibrations to an application.

The shaker 400 comprises a frame 410, a magnet unit 430, and a coil assembly 420.

The frame 410 is formed from a main frame 412 and a subframe 414 and includes an application attachment surface for attaching the shaker 400 to the application.

In this example, the attachment surface is provided by multiple attachment formations 412a (one of which can be seen in FIG. 11) configured to receive a screw which attaches the shaker to the application (as such, the application surface can be viewed as an interior screw thread of the attachment formation 412a, which in use, serves to facilitate this attachment).

In this example, the subframe 414 includes a frame element 415 and a dustcap 416, with the dustcap 416 being attached to the frame element 415. In other examples, the frame element 415 and the dustcap 416 may together be formed as an integral body.

The magnet unit 430 of the shaker 400 includes a U-yoke 434, a magnet 436 and a washer 438. The shape of the magnet unit 430 provides an annular air gap 432 in which the magnet unit 430 provides a magnetic field.

The coil assembly 420 includes a voice coil 422 mounted to a voice coil former 424. The voice coil former 424 is attached to the frame 410 at a voice coil former attachment surface 418 on the frame 410, and is configured to position the voice coil 422 in the air gap 432, when the magnet unit 430 is in a rest position and the shaker 400 is at rest.

In use, electrical current is supplied to the voice coil 422 such that a magnetic field is generated by the voice coil 422 which interacts with the magnetic field provided by the magnet unit 430 (in the air gap 432). This causes the magnet unit 430 to move relative to the voice coil 422 along a movement axis 402 of the shaker 400. Of course, movement of the magnet unit 430 relative to the voice coil 422 along the movement axis 402 can also be considered movement of the voice coil 422 relative to the magnet unit 430.

The magnet unit 430 is suspended from the frame 410 by a suspension arrangement that includes a proximal suspension 440 and a distal suspension 442. The proximal suspension 440 interconnects the frame 410 and the magnet unit 430 and the distal suspension 442 interconnects the frame 410 and the magnet unit 430. The proximal suspension 440 is closer to the voice coil former attachment surface 418 on the frame than the distal suspension 442.

In this example, the proximal suspension 440 and the distal suspension 442 are attached to the U-yoke 434 of the magnet unit 430. The U-yoke 434 has a U shape when viewed in cross-section, and comprises an annular proximal attachment surface for the proximal suspension 440 at an open end of the U-yoke 434, and an annular distal attachment surface for the distal suspension 442 at a base end of the U-yoke.

In this example, the proximal suspension 440 is connected to the frame 410 by being sandwiched between and glued to the main frame 412 and the subframe 414.

The proximal suspension 440 and the distal suspension 442 are constructed to each have a different stiffness. In this example, the distal suspension 442 has a stiffness of K₂, and the proximal suspension 140 has a stiffness of K₁, with K₁<K₂. The combined stiffness of the suspension arrangement may be given by Kₜ=K₁+K₂,

The ratio K₁/K₂ may be, for example, 0.4 or less when the shaker 400 is at rest. Therefore, the majority of the stiffness of the suspension arrangement when the shaker 400 is at rest is, in this example, provided by the distal suspension 442. The K₂ suspension may be considered to be the dominant suspension in the suspension arrangement. The K₁ suspension may be referred to as the secondary suspension and the K₂ suspension may be referred to as the primary suspension.

In this example, the distal (K₂) suspension 442 is a metal suspension. The metal suspension 442 illustrated has a flat (i.e. sheet-like) configuration and includes cut-outs, although other configurations are also possible according to the material used. However, the distal suspension 442 may have a different configuration. For example, the distal suspension 442 may be one of the different configurations of metal suspension described in the Annex below in relation to FIGS. 10A and 10B. The metal suspension 442 may be formed from steel, such as tempered stainless steel, for example AISI 301.

In this example, the distal suspension 442 is connected to the main frame 412 by a bayonet fitting, with attachment tabs 444 of the distal suspension 442 engaging with slots 413 of the main frame 412. The attachment tabs 444 of the distal suspension 442 are glued to the slots 413 of the main frame 422 when fully engaged with the slots, so as to ensure attachment and also to add some damping.

In this example, the proximal (K₁) suspension 440 is formed from an elastomeric material (for example rubber) which is configured to resiliently stretch such that the stiffness K₁ increases as the magnet unit 430 moves along the movement axis 402 away from the rest position.

In this example, the proximal (K₁) suspension 440 is air impermeable material, by virtue of being formed from an air impermeable elastomeric material. Here, the proximal suspension having the stiffness K₁, together with the frame 410, contains an air volume 443 for resisting movement of the magnet unit 430 along the movement axis 402 when the shaker 402 is activated.

In this example, the proximal (K₁) suspension 440 is a rubber suspension in the form of a flat disc extending circumferentially around the magnet unit 430.

When the proximal suspension 440 and the magnet unit 430 move towards the air volume 443 the air inside the air volume 443 may be compressed. Thus, the compressed air in the air volume 443 may resist movement of the magnet in a first direction, towards the air volume 443. The air volume 443 may also provide a negative pressure (i.e. a suctioning force) acting on the magnet unit 430 when the proximal suspension 440 and the magnet unit 430 move away from the air volume 443 in a second direction. In this way, the air volume 443 may act as an air cushion which acts as a third suspension which provides additional stiffness to influence movement of the magnet unit 430 as the magnet unit 430 moves in both first and second directions.

The air volume 443 may help to provide protection for the proximal 440 and distal 442 suspensions by alleviating stresses on the suspensions, reducing fatigue of the suspension arrangement and increasing the durability of the shaker 400. In addition, the resonant frequency of the shaker 400 and/or the amount of damping provided by the air volume 443 may be adjusted by changing the size and acoustic impedance of the air volume 443 without the need to re-design or replace the suspensions or other moving components for new applications.

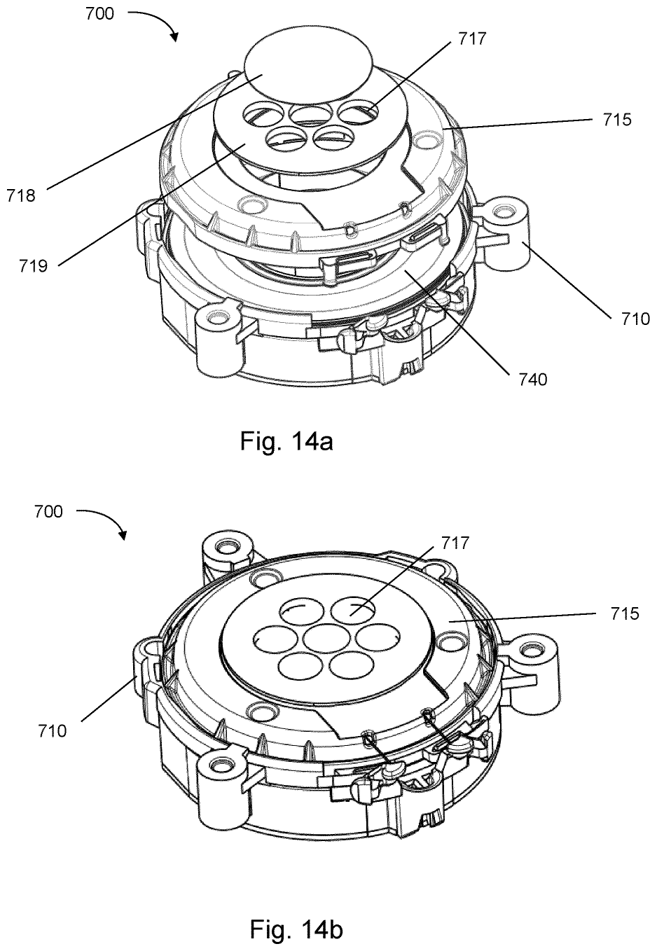

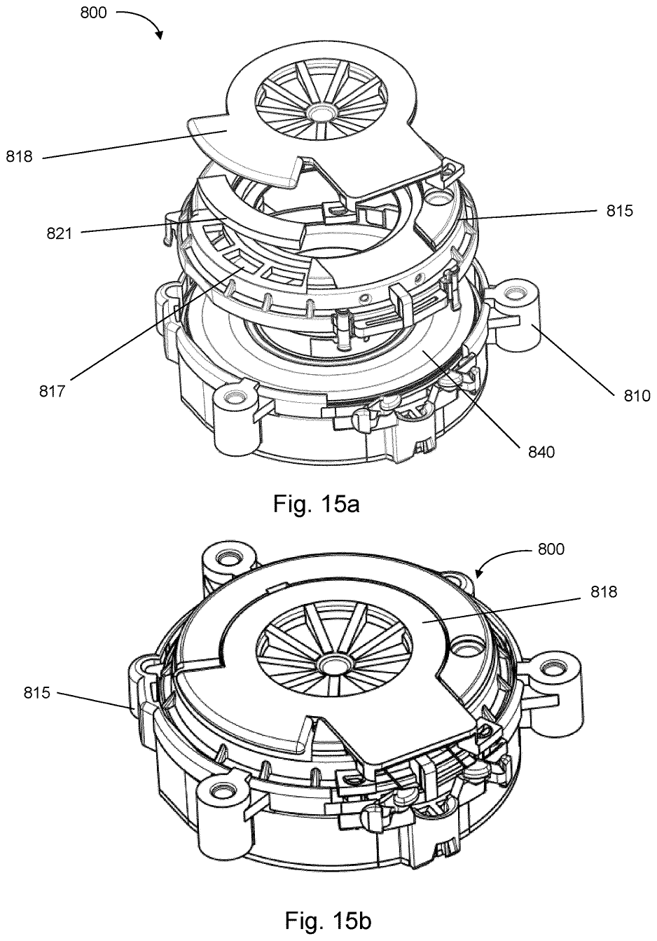

Preferably, and as exemplified below in more detail, the frame 410 may include one or more vent holes for allowing air to escape from and pass into the air volume 443 with these vent holes being covered by a material having a specific airflow resistance, so that the resonant frequency of the shaker 400 may be tuned without needing to vary the size/shape of the air volume 443. A shaker comprising vent holes is described in more detail below in relation to FIGS. 14a-15b.

In other examples the air volume 443 may be sealed (i.e. no vent holes), in which case the volume of the air volume 443 is preferably large (e.g. 20-30 cm³) and the radiator relatively small (e.g. 8-10 cm³), to get the most benefit from the air volume 443 (as discussed e.g. in Experimental Data II, below). Here “radiator” is intended to refer to the surface area of the magnet unit and part of the suspension which is configured to move in the air volume and is responsible for pressure modulation of air in the air volume.

In other examples, the air volume 443 might not be used to provide additional stiffness, e.g. by adding large holes or slots to the proximal (K₁) suspension 440, or by forming the proximal (K₁) suspension 440 from an air permeable material including an elastomeric material. In these examples, air may pass freely through the proximal (K₁) suspension 440 to and from the air volume 443, i.e. without the air volume resisting movement of the magnet unit 430 along the movement axis 402.

In one example, the application may be the seat frame of an automotive seat, which may have attachment formations with screw holes which allow screws to be used to attach the attachment formations on the automotive seat to the attachment formations 412a on the shaker 400.

FIG. 12 shows a cross-section of another example shaker 500 comprising a frame 510, a magnet unit 530 and a coil assembly 520.

The shaker of FIG. 12 has features which correspond to those of the shaker of FIG. 11 which have been given corresponding reference numerals.

A difference from the shaker of FIG. 11 is that in FIG. 12 the proximal (K₁) suspension 540 is a roll suspension which has a shallow single roll geometry. Here the proximal suspension 540 extends circumferentially around the magnet unit 530 and is formed by two concentric flat sections joined by a curved section when viewed in cross-section in a plane containing the movement axis 502. In particular, the curved section forms a single roll when viewed in cross-section in a plane containing the movement axis 502.

By including a roll geometry in the proximal suspension 540, manufacturing tolerances may be increased when the magnet unit 530 is positioned in the shaker 500. Moreover, the roll geometry may reduce stresses experienced by the connection between the proximal suspension 542 and the magnet unit 530. The roll geometry may introduce asymmetries and/or non-linearities in the stiffness provided by the proximal suspension 540 (as described below in relation to FIG. 15b).

Preferably, the roll geometry of the suspension 540 is shallow, since this helps to minimise the asymmetries in the stiffness K₁ of the proximal suspension 540 compared with if a deeper roll geometry is used while ensuring that the suspension 540 is configured to stretch within the excursion range of the magnet unit 530. If the roll geometry of the suspension 540 is too large, the suspension 540 will not stretch within the excursion range of the magnet unit 530, the stiffness of the suspension 540 will be more linear with respect to displacement, and the useful shift in resonant frequency Fₛ as the displacement increases (as discussed in more detail below) will not be achieved. Preferably, the shallow roll geometry of the suspension 540 is configured such that the stiffness of the suspension 540 at a maximum (positive or negative) displacement of the magnet unit 530 is at least twice the stiffness of the suspension 540 at the rest position.

FIG. 12 depicts a shallow roll geometry via parameters “W” and “h”. The parameter “W” is used to indicate a width of an unclamped portion of the proximal (roll) suspension 540 (i.e. a portion of the proximal (roll) suspension 540 that is free to move because it is not clamped or glued to the magnet unit 530 or the frame 510), as measured in a direction perpendicular to the movement axis 502 in a plane containing the movement axis 502 when the shaker 500 is at rest. As shown in FIG. 12, the width W extends from the magnet unit 530 (in particular, the U yoke 534 of the magnet unit 530) to an inner surface of the frame 510 corresponding to an outer periphery of the unclamped portion of the proximal suspension 540 (on one side of the movement axis 502). The parameter “h” is used to indicate a maximum extent of the proximal (roll) suspension 540, measured along the movement axis when the shaker 500 is at rest. Preferably, “h” is no more than 40%, preferably no more than 30%, preferably no more than 20% of “W”, so as to lessen the asymmetries in the stiffness of the proximal (K₁) suspension 540 (compared with if a deeper roll geometry is used). In this example, “W” is 5.7 mm and “h” is 0.97 mm.

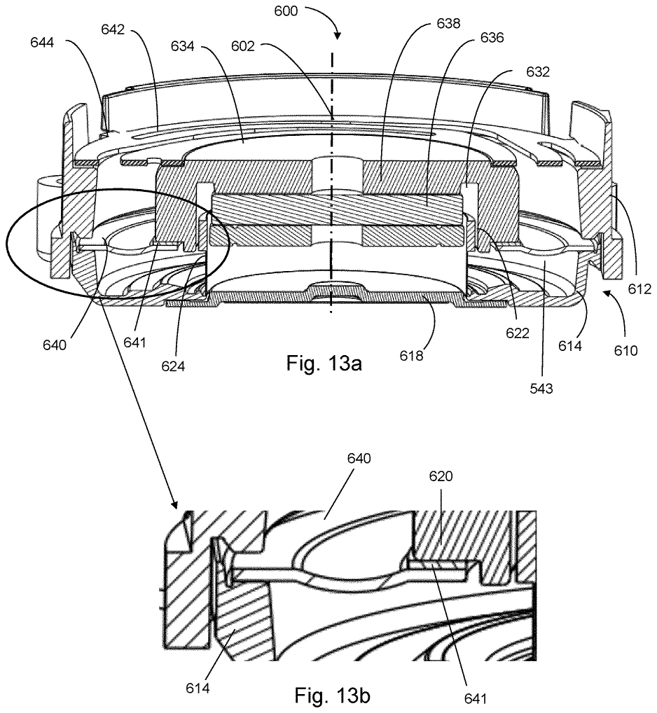

FIG. 13a shows a cross-section of another example shaker 600 comprising a frame 610, a magnet unit 630 and a coil assembly 620. FIG. 13b shows a close-up view of the proximal suspension 640.

The shaker 600 of FIGS. 13a-13b has the same features as the shaker 500 of FIG. 12. However, in this example, the proximal (K₁) suspension 640 is attached to the magnet unit 630 via an attachment ring 641.

The attachment ring 641 is attached to the proximal (K₁) suspension 640 at an inner periphery of the proximal (K₁) suspension 640 and extends circumferentially around the magnet unit 630. The attachment ring 641 is formed of a plastic (for example PC, PC-ABS, PP). However, in some examples, the attachment ring 641 may be formed from different materials such as a metal or a textile.

The attachment ring 641 is attached to the proximal (K₁) suspension 640 and the magnet unit 630, e.g. by glue. In other examples, the attachment ring 641 may be over-moulded on the magnet unit 630 and attached to the proximal (K₁) suspension by glue. Attaching the proximal (K₁) suspension 640 to the magnet unit 630 using the attachment ring 641 may be more convenient and cheaper because a more conventional glue may be used to attach the attachment ring 641 to the magnet unit 630 instead of a glue designed to bond with the elastomeric material included in the proximal (K₁) suspension 640. Moreover, the attachment ring 641 can make the suspension 640 easier to handle and position for gluing to the magnet unit 630 during assembly of the shaker 600. Additionally, variations in how the suspension 640 is attached to the U-yoke surface cause variations in stiffness and damping performance of the suspension 640. The attachment ring 641 help to counter these variations by providing a more consistent attachment method for the suspension 640 which improves the performance consistency of the shaker 600.

FIG. 14a shows an exploded view of another example shaker 700 comprising a frame 710, a magnet unit and a coil assembly. FIG. 14b shows an assembled view of the shaker 700 from FIG. 14a. Note that in FIGS. 14a-14b the shaker 700 is inverted compared to FIGS. 11-13 so that the proximal suspension 740 is positioned towards the top of the shaker 700 in FIGS. 14a-14b and the distal suspension (hidden from view by the frame 710) is towards the bottom of the shaker 700 in FIGS. 14a-14b.

The shaker 700 of FIGS. 14a-14b contains all of the features of the shaker 500 from FIG. 12, including a proximal (K₁) suspension 740 which is a roll suspension and formed from an air impermeable material. However, in this example the frame 710 includes vent holes 717 for allowing air to escape from and pass into the air volume contained by the proximal suspension 740 and the frame 710. The vent holes 717 are covered by a material having a specific airflow resistance so as to provide a predetermined resistance to the air escaping from and passing into the air volume. In this way, the airflow in and out of the air volume can be controlled to define the amount of mechanical stiffness and damping provided by the air volume and material, for resisting movement of the magnet unit. Moreover, the use of the vent holes 717 and covering material helps the resonant frequency of the shaker 400 to be tuned without needing to vary the size/shape of the air volume.

In the example of FIGS. 14a-14b the vent holes 717 are provided in an end of the frame 710 that includes the voice coil former attachment surface.

The material covering the vent holes 717 may be a textile, felt, a foam element, paper, or any other suitable microperforated material having the specific airflow resistance. In this example, the material having the predetermined specific airflow resistance is provided in the form of a cover 718, to cover the vent holes 717 provided in this part of the frame 710.

FIG. 15a shows an exploded view of another example shaker 800 comprising a frame 810, a magnet unit and a coil assembly. FIG. 15b shows an assembled view of the shaker 800 from FIG. 15a.

In FIGS. 15a-15b the vent holes 817 are provided in a side of the frame 810 at a position along the movement axis of the shaker between the voice coil former attachment surface and the proximal suspension 840.

In this example, the vent holes 817 are covered by a foam plug 821 having a specific airflow resistance so as to provide a predetermined resistance to air escaping from and passing into the air volume. Positioning the one or more vent holes 817 in a side of the frame 810 can be useful when the shaker 800 is installed in an application which could block airflow in and out of vent holes in the voice coil former attachment surface. Thus, the shaker 800 may be installed in more tightly confined spaces while still achieving a high performance.

In other examples, the one or more vent holes may be provided as an opening in the magnet unit. This arrangement may be useful for installing the shaker in applications where airflow may be limited in the region of space around the part of the frame which houses the air volume.

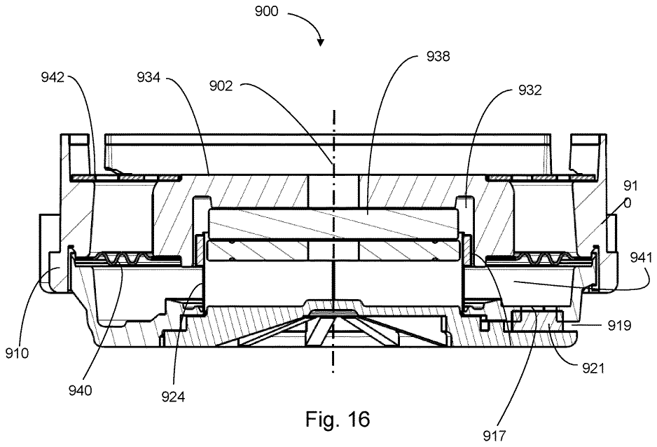

FIG. 16 shows a cross-section of another example shaker 900 comprising a frame 910, a magnet unit 930 and a coil assembly 920.

In this example the proximal suspension 940 is a textile suspension, i.e., it is made of a textile that does not include an elastomeric material. The proximal suspension includes corrugations which extend circumferentially around the magnet unit.

In this example, the proximal (K₁) suspension is formed from an air impermeable textile so that, together with the frame 910, the proximal suspension 940 contains an air volume 941 for resisting movement of the magnet unit 930 along the movement axis 902 when the shaker 900 is activated.

A vent hole 919 is provided in the frame 910 for allowing air to pass into and out of the air volume. The vent hole is covered by a foam plug 921 having a specific airflow resistance so as to provide a predetermined resistance to air escaping from and passing into the air volume 941. The foam plug 921 is positioned on the frame 910 between the vent hole 919 and an air outlet 919 provided in a side of the frame 910.

In this example, the proximal and distal suspensions provide damping of the magnet unit according to the shaker of GB2108925.5 (as described in the Annex) and the air volume acts as a third suspension providing an additional damping effect on movement of the magnet unit 932.

In other variants of the example shown in FIG. 16 (not shown), the corrugated proximal suspension 940 may be made of an elastomeric material such as rubber. In such examples, the presence of the corrugations may cause the suspension to act in a manner similar to a conventional textile suspension wherein the corrugations are configured to straighten and bend as the magnet unit moves relative to the movement axis i.e. without stretching. As such, in such examples the stiffness of the proximal suspension 940 might not increase as the magnet unit moves along the movement axis 902 away from the rest position, even though the proximal suspension 940 is made of an elastomeric material, but if the elastomeric suspension is air impermeable, the shaker would still benefit from the air volume 941 for resisting movement of the magnet unit 930 along the movement axis 902 when the shaker 900 is activated.

### EXPERIMENTAL DATA

The following discussion provides experimental data and supporting explanation which may help a reader better understand the present invention. Any theoretical explanations provided herein are provided for the purposes of improving the understanding of a reader and the inventor does not wish to be bound by any of these theoretical explanations.

### Experimental Data I

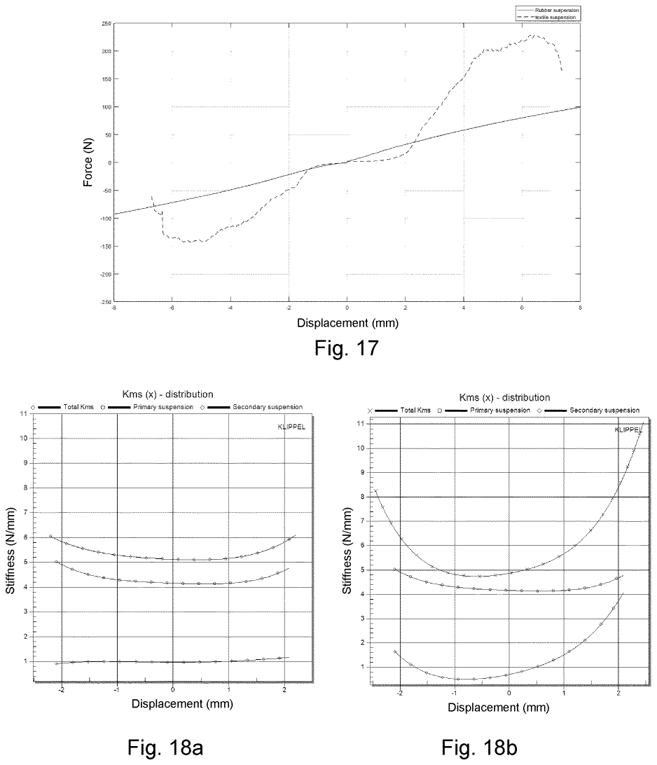

FIG. 17 illustrates how the restorative force (in Newtons) of a distal suspension and a proximal suspension varies with displacement of the magnet unit from a rest position. The variation in restorative force for a shaker having a proximal suspension made of a textile according to the disclosure of GB2108925.5 (as described in the Annex) is shown by the dotted line. The variation in restorative force for a shaker having a proximal suspension 540 which includes an elastomeric material according to the example in FIG. 12 is shown by the solid line. The proximal suspension 540 including the elastomeric material is a roll suspension made of rubber as shown in FIG. 12.

The dotted line in FIG. 17 shows how the force applied by a textile suspension is substantially constant over a typical displacement of the suspension when installed in a shaker (i.e. between −2 mm and 2 mm). At displacements above and below 2 mm the restorative force of the textile suspension increases rapidly until the textile suspension begins to tear at which point the restorative force decreases rapidly after a displacement of 6 mm.

In contrast, as shown by the solid line in FIG. 17, he restorative force (i.e., the stiffness) of the proximal suspension made of rubber increases substantially linearly over the full range of displacements. The rubber suspension being configured to stretch means that the restorative force continues to increase linearly over the full ranges of displacements without tearing. As described below in more detail, this may lead to a useful increase in the resonant frequency of the shaker. Accordingly, the magnet unit of a shaker having a proximal suspension which includes an elastic material may also experience an increased amount of mechanical damping at greater displacements which can be useful to prevent bottoming out of the magnet unit.

FIG. 18a shows a graphical representation of the stiffness distribution of a shaker having a textile proximal suspension according to GB2108925.5 (for example, the shaker 100 of FIG. 1 as described in the Annex). A displacement of 0 mm corresponds to the rest position of the shaker. In particular, FIG. 18a illustrates how the stiffness of a textile suspension and a metal suspension vary with displacement from a rest position of each suspension. The combined stiffness of the two suspension elements fits the earlier stated relationship Kₜ=K₁+K₂. The combined stiffness of the suspension increases with increasing displacement, providing a restorative force to the rest position.

FIG. 18b shows a graphical representation of the stiffness distribution of the shaker 500 of FIG. 12, which has a shallow roll geometry. In particular, FIG. 18b illustrates how the combined and individual stiffnesses of a roll suspension made of rubber suspension (which in this example is a secondary, K₁ suspension) and a metal suspension (which in this example is a primary, K₂ suspension, where K₂>K₁ when the shaker is at rest) varies with displacement from a rest position (displacement=0 mm).

As shown in FIGS. 18a-b, the stiffness of both arrangements increases with increasing displacement for each suspension. However, in FIG. 18a the textile suspension (shown by the lower line) has a more constant stiffness over displacement than the rubber suspension of the current invention shown in FIG. 18b (shown by the lower line) where the stiffness of the rubber suspension is shown to increase significantly with displacement. Accordingly, the proximal suspension made of rubber provides more stiffness which helps to control movement of the magnet unit at larger displacements of the magnet unit, thereby increasing the durability of the shaker.

FIG. 18b also shows how the stiffness of the proximal (rubber) suspension having a roll geometry results in an asymmetric stiffness profile about the rest position (displacement=0 mm). In the example shown, the stiffness of the proximal (rubber) suspension increases with displacement by a greater amount for positive displacements than for negative displacements. This is a consequence of the proximal (rubber) suspension being constructed with a shallow roll geometry. As shown by FIG. 18b, the stiffness K₁ of the proximal (rubber) suspension when the magnet unit is at a maximum positive displacement is at least two times the stiffness K₁ when the magnet unit is in the rest position, and the stiffness K₁ when the magnet unit is at a maximum negative displacement is at least two times the stiffness K₁ when the magnet unit is in the rest position.

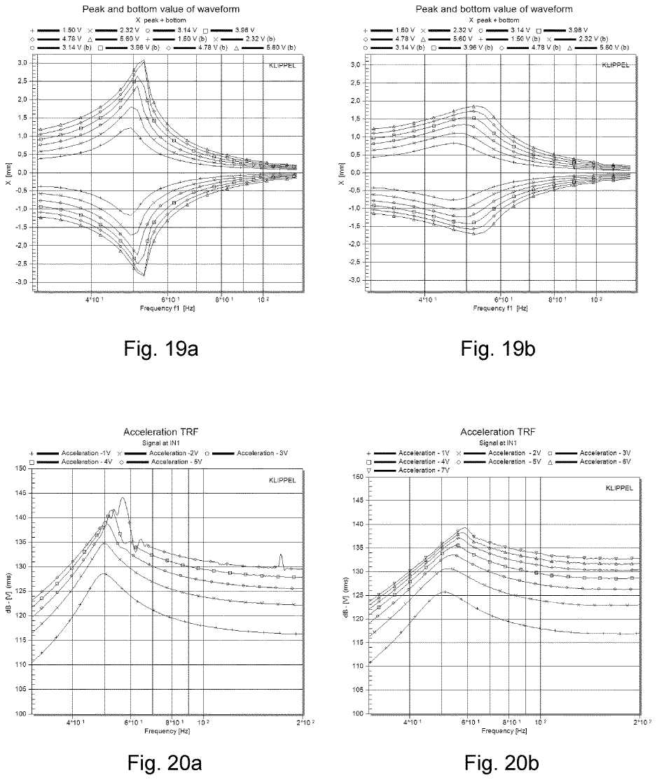

FIG. 19a shows the maximum displacement of the magnet unit against frequency for different RMS excitation voltages for a shaker having a textile proximal (K₁) suspension according to the disclosure of GB2108925.5 (see Annex).

FIG. 19b shows the maximum displacement of the magnet unit against frequency for different RMS excitation voltages for a shaker constructed according to FIG. 12, i.e., a shaker having a rubber proximal (K₁) suspension with a single shallow roll geometry.

FIGS. 20a-b shows acceleration (in dB ref. 10⁻⁶ m/s²) against frequency of the shakers used to produce FIGS. 19a-b respectively for different RMS excitation voltages. In each case the shaker is attached to a 1 kg free hanging test mass. Acceleration may be considered as a measure of how efficient a shaker is at transmitting vibrations to an application.

FIG. 19a and FIG. 20a show that the shaker of the prior art exhibits comparably higher displacement of the magnet unit at the resonant frequency Fₛ of the shaker compared to the shaker having a rubber proximal (K₁) suspension. This can cause the shaker to bottom out at the resonant frequency Fₛ. This can be seen from the artefacts visible in the graph of FIG. 19a at higher voltages which indicate that the shaker of the prior art is bottoming out.

In contrast, FIG. 19b and FIG. 20b show that the shaker having a rubber proximal (K₁) suspension exhibits a smoother performance over the frequency range without bottoming out. Consequently, the shaker of FIG. 19b and FIG. 20b may be operated at higher excitation voltages without bottoming out. Moreover, FIG. 19b and FIG. 20b show that the resonant frequency Fₛ of the shaker having a rubber proximal (K₁) suspension (indicated by the positions of the peaks) increases with the excitation voltage owing to a power compression effect of the rubber suspension. This means that a higher vibration energy of the shaker may be achieved.

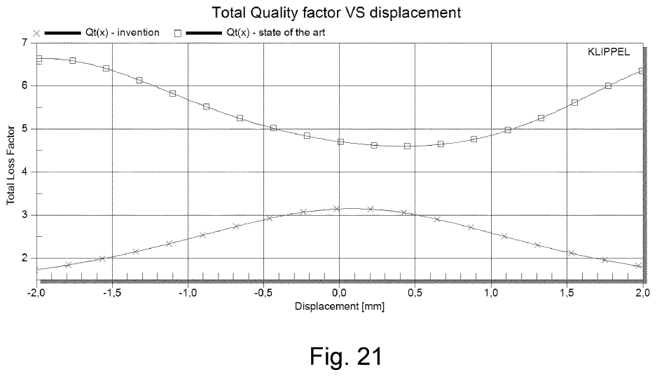

FIG. 21 shows the variation of quality factor over displacement for a shaker having a textile proximal (K₁) suspension according to the disclosure of GB2108925.5 as described in the Annex (shown by the upper curve in FIG. 21) and for a shaker having a rubber proximal (K₁) suspension and a roll geometry according to FIG. 12 (shown by the lower curve in FIG. 21).

The quality factor of a shaker may be considered as a representation of an amount of damping of the moving mass of a shaker wherein a lower quality factor indicates a higher amount of damping. In the context of a shaker, a lower quality factor is desirable at higher displacements (i.e., more damping at higher displacements).

FIG. 21 shows that the quality factor of the prior art shaker follows a conventional “U-shape”, i.e. an upright “U-shape” which is expected for conventional shakers. In contrast, the measured quality factor for the shaker of the present invention has an inverted “U-shape” shape. This is thought to be caused by the rubber element generating increasing losses of energy with increased stretching, which is believed to increasing the mechanical damping at higher displacements, in combination with the effect of the air volume with losses which introduces additional mechanical damping which is also progressive.

### Experimental Data II

A typical shaker is intended to transmit vibrations to an application in the frequency range 20-300 Hz. Usually shakers have a relatively high moving mass, in the range 40 to 200 g, so that the transmitted force to the subject body can be maximized. Such high moving mass can make the mechanical quality factor very high, typically in the range 9 to 40. This means a very high efficiency at resonance frequency, causing high accelerations but also high velocities and displacements only in a small frequency band around the resonant frequency. Since automotive shakers are typically installed inside compact seat units, they are typically required to be very shallow (thickness typically in the range 12 to 30 mm) meaning that there is limited space available in the shaker for movement of the motor system. The present inventor has observed that it may therefore be desirable to limit the displacement of the magnet unit at the resonance frequency by introducing damping of the magnet unit and, therefore, lowering the quality factor of the shaker.

In a shaker, the total quality factor may be represented as

$${Q}_{ts} = ( {Q}_{ms} * {Q}_{es} ) / ( {Q}_{ms} + {Q}_{es} )$$

where Qₘₛ is the mechanical quality factor and Qₑₛ is the electrical quality factor, substantially driven by the resistance of the voice coil R_{E} and by the force factor BI. From this it can be understood that there are different ways of lowering the total quality factor, as this can be done either acting on the electrical quality factor or on the mechanical quality factor.

Knowing that the electrical quality factor is related to the resonance frequency, moving mass, electrical resistance and force factor by the following relation:

$${Q}_{e} = \frac{{ω}_{s} {R}_{E} {M}_{ms}}{{Bl}^{2}}$$

where ωₛ is resonant angular frequency in rad/s, R_{E} is resistance of the voice coil, Mₘₛ is the moving mass and Bᵢ is the force factor.

This shows that adjusting the electrical quality factor to improve damping in the system implies increasing the force factor by using a bigger magnet and coil, which in turn causes significant extra costs and which also poses problems staying within the thickness requirements discussed above.

In contrast, in accordance with the teaching of the present disclosure, the total quality factor may be reduced by decreasing the mechanical quality factor of the shaker by introducing an elastomeric secondary suspension (e.g. made of rubber) which operates by stretching. The act of stretching is believed to help generate losses which increase as the velocity of the magnet unit increases. Velocity increases by driving the motor system with a higher voltage, meaning that when the driving voltage increases, the shaker is progressively more damped. Also, as the suspension stretches, the restoring force becomes increasingly high according to Hooke's law, causing a progressive increase in resonance frequency which generates power compression, useful to progressively limit the displacement of the motor system.

Also in accordance with the teaching of the present disclosure, the total quality factor may be reduced by decreasing the mechanical quality factor of the shaker by introducing air damping by forming the secondary suspension from a material which is air impermeable to create a sealed air volume together with the motor system and the plastics that house the voice coil. This air volume, when completely sealed, may perform as a third spring in the system, adding stiffness to the stiffness already provided by the primary and the secondary suspensions.

The stiffness of an enclosed air volume may be given by

$${K}_{am} = \frac{{ρ}_{0} {c}^{2} {S}_{D}^{2}}{Volume}$$

where ρ₀ is the density of air in Kg/m³, c is the speed of sound in air, SD is the effective radiating area (which in this example comprises the surface area of the magnet unit and part of the suspension that contributes the modulation the pressure in the air volume), and Volume is the volume of the enclosure.

A completely sealed air volume may have limited applicability in the preferred volume range of the present application (5 cm³ to 30 cm³) since the increase in resonance frequency can be too high for use as a shaker. To reduce the resonance frequency openings may be introduced in the voice coil housing. By covering the openings with a material of a suitable specific airflow resistance Rₛ, (preferably in the range 0-5000 Pa·s/m, more preferably in the range 50 to 2500 Pa·s/m) an additional and controlled amount of damping of the magnet unit may be introduced. This damping is also progressive and increases with driving voltage (and therefore with velocity).

In addition to introducing damping, the system described makes the effective volume in the enclosure change depending on the specific airflow resistance of the used material, so that the resonance frequency of the system can vary between that of a shaker in free air (where no additional stiffness is given by the air volume), when the specific airflow resistance of the covering material is very low or the covering material is absent, and that of when the magnet unit is moving in a sealed air volume (i.e. if the specific airflow resistance of the covering is very high, making the shaker appear as effectively sealed).

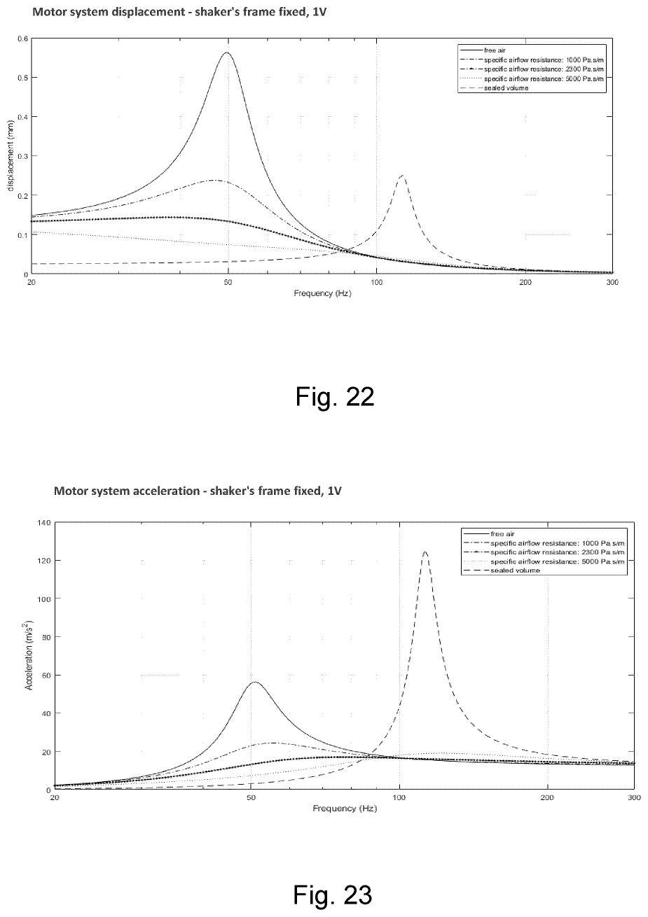

This effect is illustrated by FIGS. 22 and 23 which show displacement and acceleration respectively of the motor system of a shaker against frequency.

The shaker used to produce FIGS. 22 and 23 has the following parameters: force factor BI 4.8 [T*m], electrical resistance of the coil Re [6.8 Ohm], moving mass [58 g], total stiffness of the suspensions Kms 5.6 [N/mm], Mechanical resistance Rms 1.6 [N·s/m], radiating area SD 12.56 [cm\hat{ }2]. The shaker, having a secondary suspension made of rubber, comprises an air volume between the motor system and the voice coil housing which has a volume of 10 cm³. A vent hole, in the form of an opening, is created in the voice coil housing which has a surface area Sᵣ of 2.77 cm\hat{ }2. Each line of FIGS. 22 and 23 show the results for the opening being open (“free air”), sealed (“sealed volume”) and vent holes being covered with materials having different specific airflow resistances (1000 Pa·s/m, 2300 Pa·s/m, 5000 Pa·s/m).

FIGS. 22 and 23 show that if the opening is not covered (“free air”) the resonance frequency is located around 50 Hz. Covering the opening with materials of specific airflow resistances from 1000 to 5000 Pa·s/m, shows that damping of the magnet unit is introduced together with a shift upwards in resonant frequency. The resonant frequency reaches a maximum when the opening is completely sealed, at which point there is no more damping associated with the air volume, but only extra stiffness which sums to the stiffness of the suspensions.

The maximum achievable shift in resonant frequency depends then on the volume of enclosed air, and may be found from the formula:

$${f}_{c} = {f}_{s} * \sqrt{1 + α}$$

where α is the ratio of the acoustic compliance (inverse of acoustic stiffness described above) to the mechanical compliance of the primary and secondary suspensions. In the case analysed here, a specific airflow resistance of 2300 Pa·s/m gives a maximally flat displacement over frequency, while causing a significant loss in acceleration efficiency around the free air resonance 50 Hz.

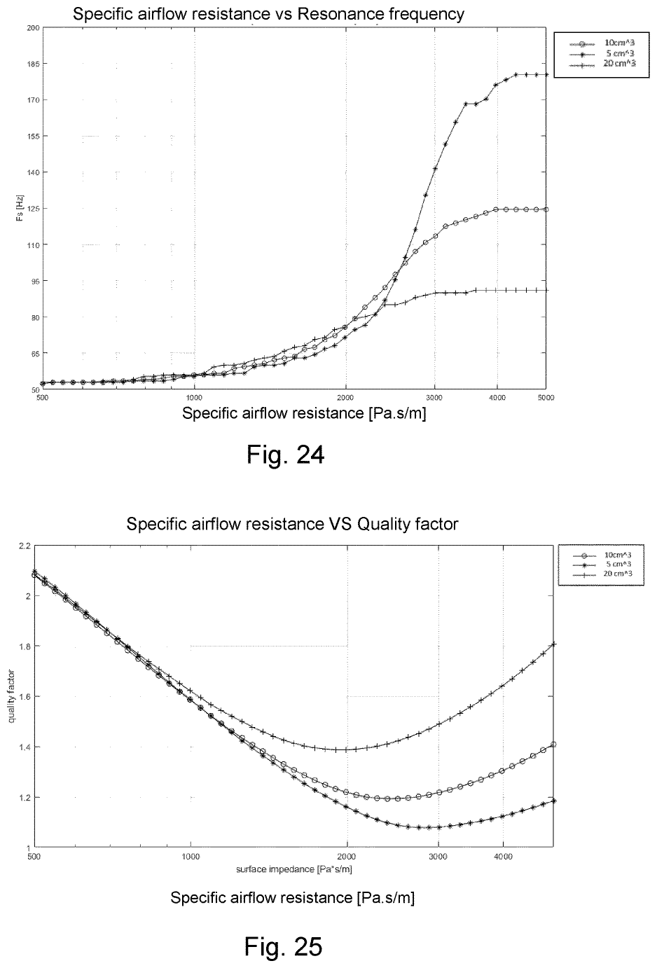

FIGS. 24 and 25 show the variation in resonant frequency Fₛ and quality factor respectively for more values of specific airflow resistance (500 to 5000 Pa·s/m) of material covering the vent holes for shakers with air impermeable proximal (K₁) suspensions for the shaker described with reference to FIGS. 22 and 23. The specific airflow resistance of the material coverings is shown for different enclosure volumes (i.e. the size of the air volume contained by the proximal (K₁) suspension and the frame). All the other shaker parameters are kept constant, as well as the open area of the opening in the voice coil housing (Sᵣ).

The acoustic impedance of a system formed of the enclosed air volume having an opening of a given size, covered by a material with a given specific airflow resistance may be calculated as

$${R}_{a} = \frac{{R}_{S}}{{S}_{r}} ,$$

where Rₐ is the acoustic impedance of system in Pa·s/m³, Rₛ is the specific airflow resistance of the material in Pa·s/m and Sᵣ is the surface area in m² of the material through which air may pass. The specific airflow resistance of the material may also be referred to the surface impedance.

As described by the formula given above in relation to Kam, the enclosure volume is inversely related to the square of the moving mass' surface area. FIGS. 23-24 show results for an effective radiating area SD of 12.56 cm².

FIG. 24 shows that the resonant frequency Fₛ is able to be increased by 30% when the specific airflow resistance of the material is changed from 500 to 2000 Pa·s/m. This increase in Fₛ is substantially independent of changes to the enclosure volume. Starting from 2000 Pa·s/m, the enclosure volume begins to have more influence on resonant frequency Fₛ, wherein small changes in the specific airflow resistance of the material coverings result in a greater increase in Fₛ. As the acoustic impedance increases, it is thought that the air in the air volume is substantially sealed inside the air volume causing the resonant frequency to stabilise at a fixed value.

FIG. 25 shows that quality factor decreases substantially linearly and independently of enclosure volume up to acoustic impedances of 1000 Pa·s/m, after which point the enclosure volume starts having higher relevance. At acoustic impedances above 2000 Pa·s/m, the quality factor starts increasing again after reaching a minimum. It is thought that this increase is because the air volume is substantially sealed at high values of acoustic impedances. This increase is more pronounced for the larger enclosure volumes shown, where the resonance frequency shift is lower.

Based on FIGS. 24 and 25, a preferred range of specific airflow resistance of the covering material for the shakers tested would be 0 to 5000 Pa·s/m, where values of specific airflow resistance around 0 would correspond to a substantially open volume. In these examples the material covering would only be intended to serve as a dust protection covering. Values of specific airflow resistance above 5000 Pa·s/m results in values of resonant frequency Fₛ which are too high for most applications (for example, in automotive seat applications) and a quality factor which begins to increase again (i.e. as shown in FIG. 25).

Based on FIGS. 23 and 24, a preferred range for enclosure volume may be 5 cm³ to 30 cm³, more preferably 10 cm³ to 30 cm³, and a preferred surface area of the moving mass (i.e. the magnet unit) may be from 3 cm² to 50 cm², more preferably 8 cm² to 20 cm².

### Experimental Data III

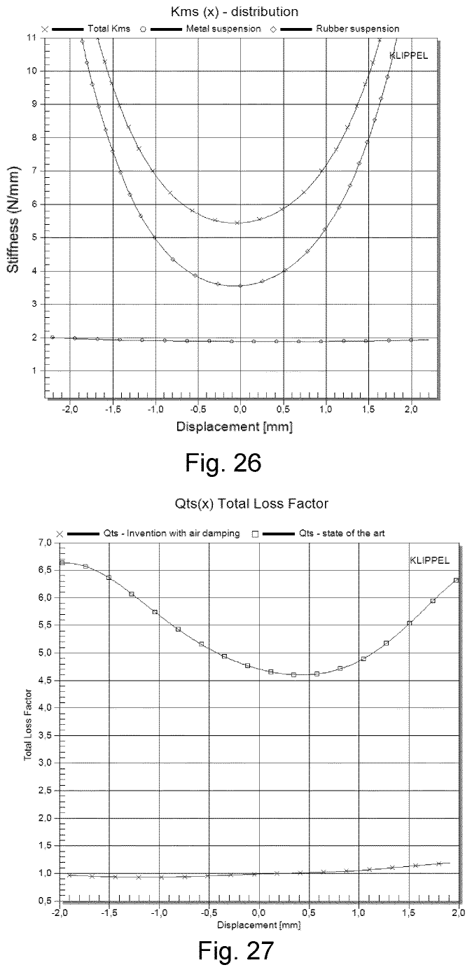

The following Figures (FIGS. 26-28) show experimental results for a shaker with a shallow roll suspension similar to that shown in FIG. 12, wherein the proximal suspension is made of rubber and the distal suspension is made of metal, and wherein the shaker also includes vent holes covered by a material with a specific flow resistance (see parameters, below). In these experiments the rubber proximal suspension has the larger stiffness K₂, and the metal distal suspension has the smaller stiffness K₁ when the shaker is at rest (i.e. in these experiments the proximal suspension including an elastomeric material is the more stiff suspension and the other, distal suspension is the less stiff suspension when the shaker is at rest). Yet, as will be shown in the following discussion, the present inventors have found that advantageous technical effects as described above can also be seen in a shaker which is implemented in this way, as shown by the following results.

FIG. 26 shows a graphical representation of the stiffness distribution of the shaker when the shaker is at rest. In particular, FIG. 26 shows how the stiffness of each suspension (the rubber proximal suspension and the metal distal suspension) varies with displacement from a rest position (displacement=0 mm).

The shaker has the following small signal parameters: force factor BI 7 [T*m], electrical resistance of the coil Re [7 Ohm], moving mass [88 g], total stiffness of the suspensions Kms 11 [N/mm], Mechanical resistance Rms 7.6 [N·s/m], radiating area SD [12.6 cm²]. Additionally, the enclosed air volume has volume of 10 cm³, the shaker comprises vent holes with a total area of 2.72 cm², and the vent holes are covered by material with specific air flow resistance 430 Pa·s/m.

In this example, the shaker is designed to handle mechanically a high electrical power, and therefore a high progressivity of the stiffness and high damping of the shaker are desirable.

As shown in FIGS. 26, the stiffness of both suspensions combined increases with increasing displacement for each suspension. This is because the stiffness of the rubber suspension is shown to increase significantly with displacement. In this shaker, the stiffness contributed by the rubber suspension is more prevalent than the metal suspension, at equilibrium position and the prevalence of the rubber suspension increases as the displacement gets larger. The metal suspension, which has a lower stiffness at rest than the rubber suspension exhibits a substantially linear behaviour over displacement as expected.

FIG. 27 shows the variation of quality factor (Qts) over displacement for a shaker of FIG. 26 compared to a shaker of the prior art (i.e., a shaker having a rubber proximal suspension and a metal distal suspension, wherein the rubber suspension has a higher stiffness at rest than the metal suspension is compared to a shaker having a textile proximal suspension).

This plot shows that the rubber suspension configured to stretch gives a high initial damping compared to a textile suspension which is not configured to stretch. As Qts is also proportional to the resonance frequency (Fs), the more progressive design in this shaker causes the Qts curve not to be reversed (in a ‘U shape’) as in the previous example of FIG. 21. Essentially, the high increase in Fs ‘masks’ the increase in damping. Therefore, the Qts curve is not reversed in this case. However, the Qts curve is more flat and lower than for Qts of the prior art shaker.

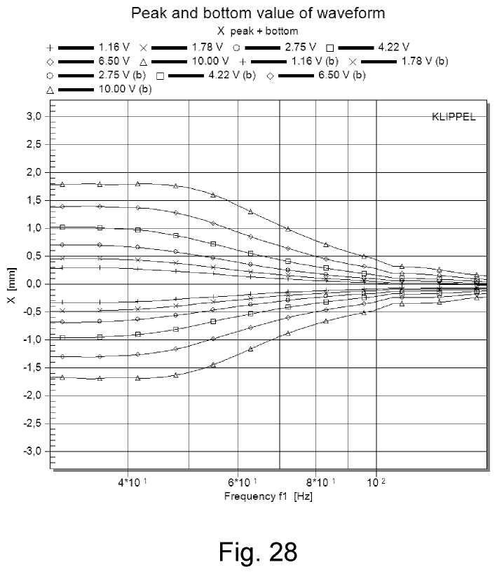

FIG. 28 shows the maximum displacement of the magnet unit against frequency for different RMS excitation voltages for the shaker of FIG. 26.

In contrast to the results for the shaker of the prior art shown in FIGS. 19a and 20a, FIG. 28 shows that the shaker having a rubber proximal suspension exhibits a smoother performance over the frequency range without bottoming out. Consequently, the shaker of FIG. 28 may be operated at higher excitation voltages without bottoming out.

### CONCLUDING STATEMENTS

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

### REFERENCES

A number of publications are cited above in order to more fully describe and disclose the invention and the state of the art to which the invention pertains. Full citations for these references are provided below.

The entirety of each of these references is incorporated herein.
U.S. Pat. No. 4,354,067 (Yamada)
U.S. Pat. No. 4,675,907 (Itagaki)
U.S. Pat. No. 6,377,145B1 (Kumagai)
U.S. Pat. No. 7,372,968B2 (Buos)
   GB2108925.5
US2013/0076162 A1

### Annex—Extracts from Gb2108925.5

This Annex contains extracts from GB2108925.5, which are included as relevant background to the present invention.

### Summary

In a first aspect, the present invention may provide: A shaker for transmitting vibrations to an application, the shaker having:
a frame, including an application attachment surface for attaching the shaker to the application;
a magnet unit configured to provide a magnetic field in an air gap;
a coil assembly including a voice coil mounted to a voice coil former, wherein the voice coil former is attached to the frame at a voice coil former attachment surface on the frame, wherein the voice coil former is configured to position the voice coil in the air gap, when the shaker is at rest;
wherein the magnet unit is configured to move relative to the voice coil along a movement axis of the shaker when the shaker is activated by supplying electrical current to the voice coil;
wherein the magnet unit is suspended from the frame by a suspension arrangement that includes a proximal suspension which interconnects the frame and the magnet unit and a distal suspension which interconnects the frame and the magnet unit, wherein the proximal suspension is closer to the voice coil former attachment surface on the frame than the distal suspension when the shaker is at rest;
wherein one of the proximal and distal suspensions has a stiffness K₁, and the other of the proximal and distal suspensions has a stiffness K₂, wherein K₂>K₁, and the ratio K₁/K₂ is 0.4 or less.

The present inventors have found that the use of two suspensions, at different locations along the movement axis, helps reduce rocking motion compared with the use of a single suspension. As there are two suspensions, there is no need to mount a suspension to act in a plane generally passing through the centre of mass of a magnet unit to reduce rocking motion (unlike Buos, described in the background section, above).

Moreover, by having one suspension (having stiffness K₂) which is dominant in providing stiffness to the suspension arrangement compared with the less stiff suspension (having stiffness K₁), it is possible for the dominant suspension to provide durability to the suspension arrangement, whilst the less stiff suspension is able to provide stability against rocking motion at lower cost than were two equally stiff suspensions used.

The shaker may be considered to be at rest when electrical current is not supplied to the voice coil.

The application may be any object or apparatus to which the shaker can be attached via the application attachment surface on the frame. In some examples, the application may be a car seat.

Stiffness is a well-understood parameter of a suspension, and may be measured by applying a controlled incremental and decremental force to the suspension element and measuring the displacement for any force applied. Techniques for measuring stiffness are well-known. In the context of the present invention, stiffness may be measured in relation to displacement of the magnet unit from its rest position (the position in which the magnet unit is at when the shaker is at rest) since as shown in FIG. 5, stiffness increases with displacement from a rest position. Similarly, resonant frequency Fₛ may be measured/calculated based on the magnet unit being in its rest position.

The stiffness K₁ may be 0.1 N/mm or higher, more preferably 0.2 N/mm or higher, more preferably 0.4 N/mm or higher.

The stiffness K₁ may be 20 N/mm or lower, more preferably 10 N/mm or lower.

In some examples, K₁ may be in the range 0.4 N/mm to 10 N/mm.

The stiffness K₂ may be 1 N/mm or higher, more preferably 2 N/mm or higher.

The stiffness K₂ may be 100 N/mm or lower, more preferably 50 N/mm or lower.

In some examples, K₁ may be in the range 2 N/mm to 50 N/mm.

Fₛ may be 30 Hz or higher, more preferably 40 Hz or higher.

Fₛ may be 200 Hz or lower, more preferably 100 Hz or lower, more preferably 70 Hz or lower.

In some examples, Fₛ may be in the range 30 Hz to 200 Hz, e.g. in the range 30 Hz to 70 Hz.

Preferably, the suspension that has the stiffness K₂ is a metal suspension, i.e. it is made of metal. A metal suspension can, by giving it a suitable geometry, be made to dominate the overall stiffness of the suspension arrangement, particularly when the suspension that has the stiffness K₁ is formed of an inexpensive material, such as a textile (e.g. a thin, polycotton sheet).

The metal suspension may be formed of sheet metal. The thickness of the sheet metal may be 1 mm or less.

The metal suspension may have one or more cutouts formed therein, to facilitate suitable behaviour. The one or more cutouts may have a spiral shape.

The suspension that has the stiffness K₂ is preferably annular, and positioned such that the suspension that has the stiffness K₂ extends circumferentially around the magnet unit.

Accordingly, the suspension that has the stiffness K₂ may include one or more (preferably more than one, preferably at least three) attachment tabs on an outer periphery thereof, wherein the one or more attachment tabs facilitate a mechanical attachment of the distal suspension to the frame. More preferably, the frame includes one or more slots, the/each slot corresponding to a respective attachment tab on an outer periphery of the suspension that has the stiffness K₂, wherein the one or more attachment tabs facilitate a mechanical attachment of the distal suspension to the frame via a bayonet fitting in which the attachment tabs engage with a respective slot in the frame. This helps facilitate accurate alignment of the suspension that has the stiffness K₂, when attaching this suspension to the frame.

Preferably, the suspension that has the stiffness K₁ is a textile suspension, i.e. it is made of a textile. Preferably, the textile suspension includes corrugations, since this can help to stiffen a textile suspension.

Of course, a skilled person will appreciate that stiffness of each suspension is partly dictated by the material of the suspension, the geometry of the suspension, and the attachment between the suspension and the frame.

The suspension that has the stiffness K₁ may be rotationally symmetric. It may be configured to be used either way around. The suspension that has the stiffness K₁ may be symmetric in other ways.

The suspension that has the stiffness K₁ is preferably annular, and positioned such that the suspension that has the stiffness K₁ extends circumferentially around the magnet unit. If the suspension that has the stiffness K₁ is a textile suspension that includes corrugations, the corrugations preferably extend circumferentially around the magnet unit.

The present inventors have found that the combination of using a metal suspension (as the suspension having stiffness K₂) and a textile suspension (as the suspension having stiffness K₁) is particularly advantageous in providing the beneficial effects noted above, as this combination is able to provide a shaker that is stable against rocking motion and easy to manufacture,

The ratio K₁/K₂ may be 0.35 or less. The ratio K₁/K₂ may be 0.3 or less, or even 0.25 or less. The lower the ratio K₁/K₂, the more dominant the suspension that has the stiffness K₂ is in providing stiffness to the suspension arrangement.

The proximal suspension may have the stiffness K₁, and the distal suspension may have the stiffness K₂. This can be helpful for ease of manufacturing in forming the shaker from its constituent parts, particularly when the frame includes a main frame and a subframe (see below). Moreover, the distal suspension is the suspension that can be exposed if protection is missing, and thus it is an advantage to have the stiffer suspension (which is more likely to be durable, and may e.g. be made of metal—see above) to be exposed, rather than the less stiff suspension (which may be made of a soft textile material, which could get damaged more easily). But it is possible instead for the proximal suspension to have the stiffness K₂ and the distal suspension to have the stiffness K₁.

The magnet unit may include a U-yoke, having a U shape when viewed in cross section, wherein the U-yoke has a base end corresponding to the base of the U shape, and an open end corresponding to the open end of the U shape. Preferably, the U-yoke is mounted in the shaker with the base end of the U-yoke further from the voice coil attachment surface than the open end of the U-yoke.

Preferably, the U-yoke includes an open end attachment surface at the open end of the U-yoke, wherein an inner periphery of the proximal suspension which interconnects the frame and the magnet unit is attached to the magnet unit at the open end attachment surface of the magnet unit.

The U-yoke may include a shoulder at its open end to provide the open-end attachment surface. The shoulder may take the form of an annular indentation formed in the open end of the U-yoke.

Preferably, the U-yoke includes a base end attachment surface at the base end of the U-yoke, wherein an inner periphery of the distal suspension which interconnects the frame and the magnet unit is attached to the magnet unit at the base end attachment surface of the magnet unit.

The U-yoke may include a shoulder at its base end to provide the base end attachment surface. The shoulder may take the form of an annular indentation formed in the base end of the U-yoke.

The shaker may be divided into a proximal side and a distal side by a mid-plane which is perpendicular to the movement axis and which passes through the voice coil when the shaker is at rest, wherein the proximal side of the shaker is on the side of the mid-plane that includes the voice coil former attachment surface, and wherein the distal side of the shaker is on the other side of the mid-plane from the distal side.

For avoidance of any doubt, the mid-plane could be at any location along the movement axis, as long as it passes through the voice coil and is not located at the ends of the shaker.

Preferably, the proximal suspension is located on the proximal side of the shaker, and the distal suspension is located on the distal side of the shaker. This helps inhibit rocking motion during use of the shaker. The base end attachment surface of the U-yoke may be located on the distal side of the shaker and the open end attachment surface of the U-yoke may be located on the proximal side of the shaker. However, other arrangements are possible.

The application attachment surface may be on the proximal side of the mid-plane or on the distal side of the mid-plane, or indeed may lie on the mid-plane, since the application attachment surface will in general vary depending on the application.

The frame may include a main frame and a subframe which are attached together, wherein the main frame includes the application attachment surface.

The main frame may include at least one distal suspension attachment surface for attaching the distal suspension thereto. The at least one distal suspension attachment surface may be provided by one or more slots in the main frame, the/each slot corresponding to a respective attachment tab on an outer periphery of the distal suspension, wherein the one or more attachment tabs facilitate a mechanical attachment of the distal suspension to the main frame via a bayonet fitting in which the attachment tabs engage with a respective slot in the frame, when attaching this suspension to the frame. In this arrangement, the distal suspension preferably has the stiffness K₂.

The subframe may include the voice coil former attachment surface.

The main frame and/or subframe may include at least one proximal suspension attachment surface for attaching an outer periphery of the proximal suspension thereto. In some embodiments, both the main frame and subframe may each include at least one proximal suspension attachment surface for attaching an outer periphery the proximal suspension thereto, wherein the outer periphery of the proximal suspension is sandwiched between at least one proximal suspension attachment surface of the main frame and at least one proximal suspension attachment surface of the subframe.

A dustcap may be part of the subframe, e.g. the dustcap by be attached to another frame element to form the subframe. The dustcap may be configured to inhibit dust from entering a U-yoke of the magnet unit.

The voice coil may include at least two layers, preferably four layers (i.e. a wire forming the voice coil may be wrapped around the voice coil former such that it forms at least two layers of wire coil), since this can aid performance of the shaker.

The air gap may extend around the movement axis.

The frame (preferably the subframe) may include one or more channels, wherein each channel is for guiding a respective wire from the voice coil out of the shaker.

In a second aspect, the present invention may provide an apparatus including:
a shaker according to the first aspect;
an application, wherein the shaker is attached to the application via the application attachment surface.

The application may be a seat, e.g. a car seat. In examples, the shaker may be attached to the seat (e.g. car seat) via a frame of the car seat, via foam in the seat, or via a stiff panel in the seat, wherein the stiff panel may form a soundboard for the shaker.

The application may be an acoustic panel, configured to produce sound when the shaker is activated by supplying electrical current to the voice coil. As is well-known in the art, an acoustic panel would typically have a high stiffness, and would be suitably damped for the purpose of making sound when vibrated at an acoustic frequency.

In a third aspect, the present invention may provide a method of forming a shaker according to the first aspect.

In a preferred example, the method may include:
attaching a voice coil former to a subframe at a voice coil former attachment surface on the subframe, wherein a voice coil mounted to the voice coil former;
attaching an open end of a U-yoke of a magnet unit to an inner periphery of the proximal suspension, wherein the magnet unit is configured to provide a magnetic field in an air gap;
attaching an outer periphery of a proximal suspension to (e.g. at least one proximal attachment surface of) the subframe;
attaching a main frame to the subframe to form a frame (optionally whilst sandwiching the outer periphery of the proximal suspension between (e.g. at least one proximal attachment surface of) the main frame and (e.g. at least one proximal attachment surface of) the subframe);
attaching an outer periphery of a distal suspension to the main frame (optionally via a mechanical attachment, e.g. via a bayonet fitting as described above); and
attaching a base end of the U-yoke of the magnet unit to an inner periphery of the distal suspension (e.g. via glue);
wherein one of the proximal and distal suspensions has a stiffness K₁, and the other of the proximal and distal suspensions has a stiffness K₂, wherein K₂>K₁, and the ratio K₁/K₂ is 0.4 or less.

This method provides a particular easy route to manufacturing a shaker that is cheap to make, and stable against rocking motions, particularly when the distal suspension has the stiffness K₂ and the proximal suspension has the stiffness K₁, and even more so when a metal suspension is used as the distal suspension having the stiffness K₂ and a textile suspension is used as the proximal suspension having the stiffness K₁.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1A shows a cut-through view of a shaker;

FIG. 1B shows a perspective cut-through view of a shaker;

FIG. 1C shows a perspective view of a shaker;

FIG. 1D shows an exploded view of a shaker;

FIG. 1E shows a bottom-up view of a shaker;

FIG. 1F shows a top-down view of a shaker;

FIG. 2 shows a simplified model of a shaker;

FIG. 3 shows results indicating a resonant frequency shift in a shaker with usage;

FIG. 4 shows a table of values indicating a resonant frequency shift in a shaker with usage;

FIG. 5 shows a graph illustrating the variation in stiffness with displacement for the suspension elements;

FIG. 6 shows a voice coil assembly;

FIG. 7 shows a subframe;

FIG. 8A shows a top-down view of a magnet unit;

FIG. 8B shows a bottom-up view of a magnet unit;

FIG. 8C shows a cut-through view of a magnet unit;

FIG. 9 shows a textile suspension;

FIG. 10A shows a range of exemplary metal suspensions; and

FIG. 10B shows an exemplary metal suspension.

### DETAILED DESCRIPTION

Aspects and embodiments of the present invention will now be discussed with reference to the accompanying figures. Further aspects and embodiments will be apparent to those skilled in the art. All documents mentioned in this text are incorporated herein by reference.

An example of a shaker 100 is illustrated in FIGS. 1A-1F.

FIGS. 1A-1F show, respectively, a cut-through view of the shaker 100, a perspective cut-through view of the shaker 100, a perspective view of the shaker 100, an exploded view of the shaker 100, a bottom-up view of the shaker 100 and a top-down view of the shaker 100 (bottom-up and top-down reference the orientation of the shaker 100 shown in FIGS. 1A-B, noting that the shaker 100 may in practice be mounted differently).

As can be seen best in FIGS. 1A-B and 1D, the shaker 100 comprises a frame 110 formed from a main frame 112 and a subframe 114.

In this example, the subframe 114 is formed by a frame element 115 and a dustcap 116, with the dustcap 116 being attached to the frame element 115. In other examples, the frame element 115 and the dustcap may together be formed as an integral body, or the dustcap 116 may be omitted.

A coil assembly 120 comprising a voice coil 122 mounted to a voice coil former 124 is attached to the subframe 114 at a voice coil former attachment surface on the subframe 114. In this example, the voice coil former 124 is sandwiched between the frame element 115 and the dustcap 116, and so the voice coil former attachment surface 115a (at which the voice coil former 124 attaches to the subframe 114) may be provided by the frame element 115 and/or by the dustcap 116.

The voice coil former 124 is configured to position the voice coil 122 within an air gap 132 provided by a magnet unit 130 of the shaker 100 (see below). The main frame 112 and/or the subframe 114 may comprise an application attachment surface for attaching the shaker 100 to an application.

In this particular example, the application is the seat frame of an automotive seat, and the application attachment surface 112a is an annular surface provided by an annular projection on the main frame 112. Multiple application attachment surfaces may be provided.

The magnet unit 130 of the shaker 100 includes a U-yoke 134, a magnet 136 and a washer 138. The shape of the magnet unit 130 provides an annular air gap 132 in which the magnet unit 130 provides a magnetic field.

In use, electrical current is supplied to the voice coil 122 such that a magnetic field is generated by the voice coil 122 which interacts with the magnetic field provided by the magnet unit 130 (in the air gap) which causes the magnet unit 130 to move relative to the voice coil 122 along a movement axis 102 of the shaker 100. Of course, movement of the magnet unit 130 relative to the voice coil 122 along the movement axis 102 can also be considered movement of the voice coil 122 relative to the magnet unit 130.

The magnet unit 130 is suspended from the frame 110 via a suspension arrangement that includes a proximal suspension 140 which interconnects the main frame 112 and the magnet unit 130 and a distal suspension 142 which interconnects the main frame 112 and the magnet unit 130. The proximal suspension 140 is closer to the voice coil former attachment surface 115a than the distal suspension 142.

In this example, the proximal suspension 140 and the distal suspension are attached to the U-yoke 134 of the magnet unit 130. The U-yoke 134 has a U shape when viewed in cross-section, and comprises an annular proximal attachment surface for the proximal suspension 140 at the open end of the U-yoke 134, and an annular distal attachment surface for the distal suspension 142 at the base end of the U-yoke.

As can be seen best in FIG. 1B, the U-yoke 134 includes a shoulder at its open end to provide an open end attachment surface for the proximal suspension 140. This assists with gluing.

As can be seen best in FIG. 1B, the U-yoke 134 includes a shoulder at its base end to provide a base end attachment surface for the distal suspension 142. This assists with gluing.

In this example, the proximal suspension 140 is connected to the frame 110 by being sandwiched between and glued to the main frame 112 and the subframe 114.

In this example, the distal suspension 142 is connected to the main frame 112 by a bayonet fitting, with attachment tabs 144 of the distal suspension 142 engaging with slots 113 of the main frame 112. The attachment tabs 144 of the distal suspension 142 are glued to the slots 113 of the main frame 122 when fully engaged with the slots, so as to ensure attachment and also to add some damping.

The shaker 100 may be manufactured by:
attaching the voice coil former 124 to the subframe 114 at a voice coil former attachment surface on the subframe 114 (e.g. by gluing the voice coil former 124 to both the frame element 115 and the dustcap 116), wherein a voice coil 122 is mounted to the voice coil former 124;
attaching (the open end attachment surface at) the open end of the U-yoke 134 of the magnet unit 130 to the inner periphery of the proximal suspension 140;
attaching an outer periphery of the proximal suspension 140 to (the frame element 115 of) the subframe 114;
attaching the main frame 112 to (the frame element 115 of) the subframe 114 to form the frame 110, whilst sandwiching the outer periphery of the proximal suspension 140 between the main frame 112 and (the frame element 115 of) the subframe 114;
attaching an outer periphery of the distal suspension 142 to the main frame 112 (via the bayonet fitting described above); and
attaching (the base end attachment surface at) the base end of the U-yoke 134 of the magnet unit 130 to an inner periphery of the distal suspension 142.

Since the distal suspension 142 is fitted via a bayonet fitting, the distal suspension 142 can be accurately aligned with the remaining components of the shaker 100, with respect to the movement axis 102 of the shaker 100, and indeed may serve to align the remaining components of the shaker by positioning the magnet unit 130 and proximal suspension 140 within the shaker 100.

The proximal suspension 140 and the distal suspension 142 are constructed to each have a different stiffness. In this example, the distal suspension 142 has a stiffness of K₂, and the proximal suspension 140 has a stiffness of K₁, with K₁<K₂. The ratio K₁/K₂ may be, for example, 0.4 or less. Therefore, the majority of the stiffness of the suspension arrangement is, in this example, provided by the distal suspension 142. This may be achieved, for example, by forming the proximal suspension 140 from a textile and forming the distal suspension 142 from metal.

By way of example, K₂ may be from 3 N/mm (with e.g. K₁=1 N/mm, total stiffness (K₁+K₂)=4 N/mm, K₁/K_{2=0.25} for resonant frequency Fₛ=35 Hz with 86 g moving mass) to 28 N/mm (with e.g. K₁=10 N/mm, total stiffness (K₁+K₂)=38 N/mm, K₁/K_{2=0.35}, Fₛ=100 Hz with 86 g moving mass) calculated with a K₁/K₂ ratio of 0.2.

A simplified model of a shaker 200, which can be used to understand the shaker 100 of FIG. 1, is illustrated in FIG. 2. Alike features have been given alike reference numerals throughout this disclosure.

The shaker 200 of FIG. 2 comprises a moving mass 230. The moving mass 230 has a mass of Mm. The moving mass 230 is suspended from a frame 210 by a proximal suspension 240 and a distal suspension 242, and is mounted about voice coil assembly 220. The proximal suspension 240 has a stiffness K₁, and the distal suspension 242 has a stiffness K₂. The combined stiffness of the suspension is Kₜ=K₁+K₂, and the resonant frequency of the system, Fₛ, can be calculated as

$${F}_{S} = \frac{1}{2 π} . / \frac{\overline{{K}_{t}}}{{M}_{m}}$$

(with Fₛ in units of Hz, Kₜ in units of N/m and mass in units of kg). The stiffness of the proximal suspension 240 and the distal suspension 242 may change over time or through usage, and this can therefore affect the resonant frequency, Fₛ, of the system. Some materials are more susceptible to this change than others. For example, the stiffness of a suspension formed from textile may vary more over time than the stiffness of a suspension formed from metal.

The results of an experiment to illustrate this change are illustrated in FIG. 3. The resonant frequency, Fₛ, for a mass wherein each of the proximal suspension 240 and the distal suspension 242 are formed of textile is measured both before and after an accelerated aging test. In this case, the resonant frequency, Fₛ, shifts from −67 Hz to −40 Hz, a >40% drop.

Use of a material that is less susceptible to change in stiffness can lessen or mitigate this shift. For example, the proximal suspension 240 and the distal suspension 242 may be formed from a material such as metal. Metal is a more durable material for forming a suspension. However, suspension formed of such materials metal causes a significant increase in cost for the apparatus. Therefore, whilst a shaker comprising metal proximal suspension 240 and metal proximal suspension 242 may offer higher durability, this is offset against increased material costs and increased manufacturing complexity.

The present inventors have realised that, since Fₛ depends on the entire stiffness of the suspension (i.e. the sum of the stiffnesses of the individual components Kₜ=K₁+K₂), providing an arrangement with a dominant suspension (i.e. a suspension which contributes more than half of the total stiffness) formed of a more durable material and a secondary suspension (i.e. a suspension which contributes less than half of the total stiffness) formed of a less durable material can provide an improvement in durability with a reduced increase in manufacturing complexity or material cost, whilst still getting the improved stability against rocking motion obtained by having two suspensions. The improved durability is believed to be provided, at least in part, because the dominant suspension helps to protect the secondary suspension from aging, and also because the suspension helps to limit the impact of any aging in the secondary suspension (since a change in stiffness of the secondary suspension is a smaller proportion of the entire stiffness, and therefore the overall change is reduced).

For example, the stiffness K₁ of the secondary suspension may provide less than 29% of the total stiffness Kₜ (K₁/K₂ is 0.4 or less), less than 26% of the total stiffness Kₜ (K₁/K₂ is 0.35 or less), less than 23% of the total stiffness Kₜ (K₁/K₂ is 0.3 or less), or less than 20% of the total stiffness Kₜ (K₁/K₂ is 0.25 or less). The lower the ratio K₁/K₂, the more dominant the suspension that has the stiffness K₂ is in providing stiffness to the suspension arrangement, and therefore the less impact any change in stiffness K₁ has on the overall stiffness Kₜ.

Results from a comparative experiment are illustrated in FIG. 4. The table of values indicate the measured resonant frequency at certain intervals during the same accelerated aging test used to produce the results shown in FIG. 3 (note: the steps shown in the different rows are part of a single test). Such tests are well-known in the industry, though the details of the test used may vary from manufacturer to manufacturer.

In the dominant metal/textile setup, the metal suspension stiffness K₂ contributes 82% of the total suspension stiffness, while the textile suspension stiffness K₁ contributes 18% of the total suspension stiffness (K₁/K_{2=0.22}). It is clear that this arrangement provides a significant improvement in the durability of the unit. In particular, the shift in resonant frequency is reduced from a 40% reduction to an 11% reduction at completion of the aging test (see final row of FIG. 4), illustrating the technical improvement provided by the suspension arrangement.

A graphical representation of the stiffness distribution of the shaker 100 shown in FIG. 1 is illustrated in FIG. 5. In particular, FIG. 5 illustrates how the stiffness of the textile suspension 140 and metal suspension 142 vary with displacement from a rest position of each suspension. In each case, the stiffness of the suspension increases with increasing displacement, providing a strong restorative force to the rest position. As shown here, the stiffness increase with increasing displacement for each suspension is continuous and gradual, since the displacements are not so high as to break the suspensions. The combined stiffness of the two suspension elements fits the earlier stated relationship Kₜ=K₁+K₂, thereby validating this understanding of the contribution of the first and second suspension elements to the overall stiffness of the suspension.

In the context of the present invention, stiffness and resonant frequency Fₛ may be measured in relation to the magnet unit being at its rest position (Displacement=0 mm, on FIG. 5).

The following description and associated FIGS. 6-10 provide further specific details of the implementation of a seat shaker 300, which implements essentially the same design as the seat shaker 100, to aid understanding of the present invention.

FIG. 6 illustrates a voice coil assembly 320 comprising a voice coil 322 and a voice coil former 324. The voice coil 322 is formed as a 4-layer thick coil of wire about the voice coil former, and is terminated in two lead-out wires 326. Other configurations of the voice coil 322 may also be utilised, for example with a different number of layers, though at least three layers, preferably four layers, is believed to help optimise performance. The height of the voice coil 322 on the voice coil former (dimension 3201), the height of the exit point of lead-out wire 326 (dimension 3202) and the separation between the lead-out wires 326 (dimension 3203) can be varied as required for installation in a shaker.

FIG. 7 illustrates a frame element 315 of a subframe having a voice coil assembly 320 attached thereto. The frame element 315 includes channels 317 to guide the lead-out wires 326 of the voice-coil assembly 320 via holes 317a to connection tabs 328 (although connection tabs 328 can be seen in FIG. 7, the lead-out wires 326 connect to the connection tabs 328 on the opposite side of the frame element 315 from the side that is shown in FIG. 7). Said connection tabs 328 can be used to connect the voice coil assembly 320 to a source of electrical power, for example by soldering an electrical power source to the connection tabs 328. The use of channels 317 can reduce a requirement for tight manufacturing tolerance in the voice coil assembly 320, e.g. by making the channels 317 adequately wide. The use of channels 317 also helps guide the lead-out wires to the exit holes 317a to land properly on the connection tabs 328.

FIGS. 8A, 8B and 8C illustrate top, bottom and cut-through views of a magnet unit 330 for use in a shaker. FIG. 8A illustrates the magnet unit 330 as viewed from the base end of the U-yoke 334, while FIG. 8B illustrates the magnet unit 330 as viewed from the open end of the U-yoke 334 such that washer 338 and air gap 332 are visible. FIG. 8C shows a cut-through view of the magnet unit 330 mounted via a proximal suspension 340 to a frame 312. The shaker as illustrated in FIG. 8C is oriented upside down when compared to the illustrations of, e.g. FIG. 1 (in that the voice coil former attachment surface—not illustrated—would be located at the top of the image rather than at the bottom). Of the magnet unit 330, the U-yoke 334 provides much of the moving mass Mm of the magnet unit 330, and the mass of the U-yoke 334 can be varied by varying, for example, the wall thickness of the U-yoke 334. The magnet unit 330 further comprises a washer 338, a magnet 336 (not visible in FIGS. 8A-B), and provides a magnetic field in the air gap 332.

At the base end of the U-yoke 334, a shoulder provides a distal suspension attachment surface 3341 for attaching (by glue) a distal suspension 342 to the base end of the U-yoke 334.

At the open end of the U-yoke 334, another shoulder provides a proximal suspension attachment surface 3342 for attaching a proximal suspension 340 to the open end of the U-yoke 334.

The shoulders in the U-yoke help to facilitate attachment of the suspensions 340, 342 to the U-yoke, e.g. by helping to prevent or reduce glue from entering, for example, the air gap 332. The width of the shoulders can be varied to ensure optimal adhesion of the proximal and distal suspension. For example, if the width of the surface 3341 or the surface 3342 is too small, then attachment would be very difficult.

FIG. 9 illustrates a portion of a textile suspension 340, which may form a proximal suspension in a shaker. The suspension includes a corrugated portion having corrugations 3402. The corrugations 3402 increase the stiffness of the textile suspension 340. The design of the textile suspension 340 is configured to allow the textile suspension 340 to be installed either way up in a shaker, by the gluing surfaces 3404a and 3404b lying on the same plane, and by having the same stiffness behaviour regardless of which way up the textile suspension 340 is mounted. This helps simplify the manufacturing of the shaker.

The gluing surfaces 3404a, 3404b for attaching the textile suspension to a frame and a magnet unit of a shaker are therefore located at a same level within the textile suspension. In other words, height dimension 3408 is the same for each of the top and bottom surfaces of the textile suspension 340, and each of the inner and outer surfaces of the textile suspension 340. Furthermore, the textile suspension 340 is configured to have symmetrical stiffness, such that the performance of the textile suspension 340 is not affected by its orientation in the shaker. Therefore, the corrugations 3402 are equally spaced, such that dimension 3406 is equal for each of the corrugations 3402. The length of the corrugations 3402 and the textile suspension 340 may be set such that the textile suspension 340 is not fully stretched during normal operation to prevent a non-linear change in stiffness and consequently less predictable operation, and also to prevent excessive stresses on the textile suspension 340 which could damage the textile suspension 340 over time.

FIGS. 10A and 10B illustrate different configurations of a metal suspension 342a, 342b, 342c which may form a distal suspension in a shaker. The metal suspension 342a, 342b, 342c may be formed from steel, such as tempered stainless steel, for example AISI 301. The metal suspension 342 illustrated has a flat (i.e. sheet-like) configuration and may include cutouts 346, although other configurations are also possible according to the material used. The flat shape of the metal suspension 342a, 342b, 342c may aid attachment (e.g. gluing) to a magnet unit of a shaker. The cutouts 346 are configurable to control the mechanical performance (e.g. strength, stiffness, fatigue resistance) of the metal suspension 342a, 342b, 342c. Metal suspensions 342b, 342c include attachment tabs 344 for attachment to a frame of a shaker, for example via a bayonet fitting as described above.

The metal suspension 342a, 342b, 342c may be formed by, for example, cutting from a sheet of metal such as stainless steel. A suitable thickness of the metal sheet may be, for example, 0.5 mm. This can provide a resonant frequency, Fₛ, of ˜50 Hz for a moving mass Mm of ˜60 g. For ease of handling, it is preferable that there are no burrs or sharp edges present on the metal suspension 342a, 342b, 342c so as to avoid local stresses on the component, friction on other components of the shaker and/or injuries to a person handling the component.

The metal suspension 342a, 342b, 342c may be configured to provide a particular stiffness, K₂, to thereby result in a desired resonant frequency Fₛ of a shaker. For example, the design parameters include the thickness and type of the sheet metal, the length and width of the cutouts 346, the number of cutouts 346 and the radius of the cutouts 346. The areas of metal between the cutouts may be referred to as arms 348. Longer and thinner arms tend to provide a lower overall stiffness K₂, as does increased radius at an end of an arm 348. A lower stiffness of the material and of the designed suspension 342a, 342b, 342c can lead to lower stresses on the arms 348 of the metal suspension 342a, 342b, 342c, and hence improved fatigue resistance. Fatigue can occur when the metal suspension 342 is vibrated, and can lead to cracks or failure of the metal suspension 342a, 342b, 342c.

1-27. (canceled)

28. A shaker for transmitting vibrations to an application, the shaker having:
a frame, including an application attachment surface for attaching the shaker to the application;
a magnet unit configured to provide a magnetic field in an air gap;
a coil assembly including a voice coil mounted to a voice coil former, wherein the voice coil former is attached to the frame at a voice coil former attachment surface on the frame, wherein the voice coil former is configured to position the voice coil in the air gap, when the magnet unit is in a rest position and the shaker is at rest;
wherein the magnet unit is configured to move relative to the voice coil along a movement axis of the shaker when the shaker is activated by supplying electrical current to the voice coil;
wherein the magnet unit is suspended from the frame by a suspension arrangement that includes a proximal suspension which interconnects the frame and the magnet unit and a distal suspension which interconnects the frame and the magnet unit, wherein the proximal suspension is closer to the voice coil former attachment surface on the frame than the distal suspension when the shaker is at rest;
wherein one of the proximal and distal suspensions includes an elastomeric material which is configured to resiliently stretch such that the stiffness of the suspension that includes the elastomeric material increases as the magnet unit moves along the movement axis away from the rest position.

29. A shaker according to claim 28, wherein the suspension that includes the elastomeric material is configured such that:
the stiffness of the suspension that includes the elastomeric material when the magnet unit is at the maximum positive displacement is at least two times the stiffness of the suspension that includes the elastomeric material when the magnet unit is in the rest position; and
the stiffness of the suspension that includes the elastomeric material when the magnet unit is at the maximum negative displacement is at least two times the stiffness of the suspension that includes the elastomeric material when the magnet unit is in the rest position.

30. A shaker according to claim 28, wherein the suspension that includes the elastomeric material is a flat disc extending circumferentially around the magnet unit.

31. A shaker according to claim 28, wherein the suspension that includes the elastomeric material is a roll suspension.

32. A shaker according to claim 31, wherein the suspension that includes the elastomeric material has a single roll geometry wherein a maximum extent of the roll suspension, measured along the movement axis, is no more than 40% of a width of an unclamped portion of the roll suspension as measured in a direction perpendicular to the movement axis in a plane containing the movement axis on a same side of the movement axis, when the shaker is at rest.

33. A shaker according to claim 28, wherein the suspension that includes the elastomeric material is attached to the magnet unit via an attachment ring.

34. A shaker according to claim 33, wherein the attachment ring is formed of a plastic, wherein the other of the proximal and distal suspensions is a metal suspension.

35. A shaker according to claim 28, wherein the suspension that includes the elastomeric material is the proximal suspension, and the other of the proximal and distal suspensions is the distal suspension.

36. A shaker according to claim 28, wherein the shaker has a resonant frequency Fₛ, in the range 30 Hz to 200 Hz.

37. A shaker according to claim 28, wherein one of the proximal and distal suspensions has a stiffness K₁, and the other of the proximal and distal suspensions has a stiffness K₂, wherein K₂>K₁ when the shaker is at rest, and the ratio K₁/K₂ is 0.4 or less when the shaker is at rest.

38. A shaker according to claim 37, wherein the suspension that includes the elastomeric material has the stiffness K₁, and the other of the proximal and distal suspensions has the stiffness K₂.

39. A shaker according to claim 28, wherein the suspension that includes the elastomeric material is formed from an air impermeable material, and the suspension that has the elastomeric material, together with the frame, is configured to contain an air volume for resisting movement of the magnet unit along the movement axis when the shaker is activated.

40. A shaker according to claim 39, wherein the frame and/or magnet unit include one or more vent holes for allowing air to escape from and pass into the air volume.

41. A shaker according to claim 40, wherein the/each vent hole is covered by a material having a specific airflow resistance in the range 50 to 2500 Pa·s/m.

42. A shaker according to claim 39, wherein the volume of the air volume is in the range 5 cm³ to 30 cm³

43. A shaker according to claim 39, wherein the surface area of a part of the magnet unit which is configured to move inside the air volume is in the range 3 cm² to 50 cm².

44. A shaker according to claim 39, wherein one of the proximal and distal suspensions includes an elastomeric material which is configured to resiliently stretch such that the stiffness of the suspension that includes the elastomeric material increases as the magnet unit moves along the movement axis away from the rest position.

45. A shaker according to claim 39, wherein the air impermeable suspension includes an elastomeric material which is configured to resiliently stretch such that the stiffness of the suspension that includes the elastomeric material increases as the magnet unit moves along the movement axis away from the rest position, wherein the other of the proximal and distal suspensions is a metal suspension.

46. A shaker according to claim 39, wherein one of the proximal and distal suspensions has a stiffness K₁, and the other of the proximal and distal suspensions has a stiffness K₂, wherein K₂>K₁ when the shaker is at rest, wherein the ratio K₁/K₂ is 0.4 or less when the shaker is at rest, wherein the air impermeable suspension has the stiffness K₁ when the shaker is at rest.

47. A shaker for transmitting vibrations to an application, the shaker having:
a frame, including an application attachment surface for attaching the shaker to the application;
a magnet unit configured to provide a magnetic field in an air gap;
a coil assembly including a voice coil mounted to a voice coil former, wherein the voice coil former is attached to the frame at a voice coil former attachment surface on the frame, wherein the voice coil former is configured to position the voice coil in the air gap, when the shaker is at rest;
wherein the magnet unit is configured to move relative to the voice coil along a movement axis of the shaker when the shaker is activated by supplying electrical current to the voice coil;
wherein the magnet unit is suspended from the frame by a suspension arrangement that includes a proximal suspension which interconnects the frame and the magnet unit and a distal suspension which interconnects the frame and the magnet unit, wherein the proximal suspension is closer to the voice coil former attachment surface on the frame than the distal suspension when the shaker is at rest;
wherein one of the proximal and distal suspensions is air impermeable, wherein the air impermeable suspension, together with the frame, is configured to contain an air volume for resisting movement of the magnet unit along the movement axis when the shaker is activated.
